(19) United States
(12) Patent Application Publication
(10) Pub. No.: US 2004/0186594 A1
(43) Pub. Date: Sep. 23, 2004

(54) Information processing system, information processing apparatus and method, recording medium and program

(76) Inventors: Kazumoto Kondo, Tokyo (JP); Naoki Fujisawa, Tokyo (JP); Minako Takahashi, Tokyo (JP); Arito Kobayashi, Kanagawa (JP)

Correspondence Address: FROMMER LAWRENCE & HAUG LLP, 745 FIFTH AVENUE, NEW YORK, NY, 10151, US

(21) Appl. No.: 10/801,767

(22) Filed: Mar. 16, 2004

(30) Foreign Application Priority Data
Mar. 18, 2003 (JP) P2003-073074

(51) Int. Cl. G05B 15/02; G05B 19/18; G05B 11/01; G09D 3/04

(52) U.S. Cl. 700/9; 700/19; 700/20

(57) ABSTRACT

An arrangement in which plural users read a preset picture at different places and in which the attention of the users is directed in real-time to the picture. To this end, a picture management server 2 supervises an album made up by plural pictures. In the so supervised album, an URL is allocated to each picture. In case a PC 4-1 and a PC 4-2 acquire album data from the picture management server 2, plural pictures, derived from the album data, are demonstrated on respective display units. When a cursor of the PC 4-1, so far located on a preset picture, is moved, the URL of the picture of the destination of the movement is transmitted to the PC 4-2. The PC 4-2 causes movement of the cursor to the picture associated with the URL received. The arrangement may be applied to a personal computer configured for reading a digitized album or to a server supervising the album.

### TECHNICAL FIELD

This invention relates to an information processing system, an information processing method, an information processing apparatus, a recording medium and a program. More particularly, it relates to an information processing system, an information processing method, an information processing apparatus, a recording medium and a program, that may be used with advantage when plural users read pictures, that may be acquired over a network in real-time.

### BACKGROUND ART

Among albums having plural photos, affixed to album sheets, an album made of paper medium preexisted for long, and are still used. In order for plural readers to read an album of the paper medium simultaneously, it needs to be read at the same place. Recently, as the network has become popular, it has become possible for plural readers to read the same album at different places (at different spatial locations) simultaneously.

The album that may be read over the network is digitized, in distinction from the album of the paper medium, so that the same album may be read simultaneously at different places by plural users, on the condition that data of the same album are owned by these users.

The digitized album is sent from the reader A to the reader B by being attached to e.g. an E-mail, and the reader B then receives and reproduces the data of the same album, thus forwarded, to read the album. In this manner, the same album may be read at different places.

There are occasions where such digitized album is stored in e.g. a sole server and managed. If a reader accesses the server, the album managed by the server is supplied to the reader who accessed, so that it is now possible for plural readers to read the same album at different places (see for example the Patent Reference Material 1).

The album managed by the server may be updated extremely readily by the user as a manager for the album. Due to such ease in operation, the act of album reading via server is becoming popular.

[Patent Reference Material]

Japanese Laying-Open Patent Publication H-11-203359

In the case of an album of paper medium, plural readers must be in the same spatial location if they are to read the same album, as described above. Or, the plural readers must read the album separately at different time. Conversely, a digitized album can be read by plural readers at different spatial locations and, in addition, at the same time point. This accounts for the high degree of freedom and convenience in use of the digitized album.

In the case of an album of the paper medium, attention of plural users may be invoked to the same photo (picture) if, as the same album is read by plural readers in the same spatial location, one of the users points to one of the photos as “this photo”. This accounts for the advantage of the album of the paper medium over the digitized album insofar as the feature of “enjoying the reading together”.

If it is desired to do the same thing in the case of a digitized album, that is, if plural readers read the same album at the same time point and at different places, and the attention of the readers is to be invoked to a certain picture, it is necessary for one of the readers desirous to invoke the attention of the other readers to send a message: “a photo second from left and third from top” to these other readers by some means or other. This point is felt to be a defect in convenience in use of the digitized album as compared to the paper album as regards “co-enjoyment”.

### SUMMARY OF THE INVENTION

In view of the above-depicted status of the art, it is an object of the present invention to provide a digitized album with improved convenience in use by realization of the merit of the paper album in the digitized album.

In one aspect, the present invention provides an information processing system made up by a first apparatus for supervising data, a second apparatus for exploiting the data, and a third apparatus for connecting the second apparatus to another apparatus, in which the information processing system comprises supplying means for supplying the data from the first apparatus to the second apparatus, connecting means for connecting the second apparatus to the other apparatus over a network by the third apparatus, and transmitting means for transmitting the data supplied by the supplying means to the second apparatus from the second apparatus, connected by the connecting means, to the other apparatus.

The first apparatus may supervise first picture data of a thumbnail picture, a first URL associated with the first picture data, a second URL associated with the first URL and second picture data for enlarged display of the thumbnail picture associated with the second URL.

In case the first URL is supplied by the supplying means, the first URL may be sent to the other apparatus by the transmitting means, and the other apparatus may include means for acquiring, from the first apparatus, the first picture data associated with the first URL transmitted from the transmitting means.

The second apparatus may be supplied from the first apparatus with the first URL and, in case the second picture data for enlarging a thumbnail picture corresponding to the first URL has become necessary, the second apparatus may sends the first URL to the first apparatus and acquire the second URL, returned from the first apparatus as being associated with the first URL. The second apparatus may further acquire the second picture data from the first apparatus based on the second URL acquired.

The data transmitted by the transmitting means is sent to the other apparatus through the third apparatus.

In another aspect, the present invention provides an information processing apparatus comprising first acquisition means for acquiring a first URL associated with first picture data supervised by a first apparatus, connection means for connecting to a second apparatus for exchanging data therewith, first supplying means for supplying the first URL, obtained by the first acquisition means, to the second apparatus, connected by the connecting means, second acquisition means for accessing the first apparatus, based on the first URL, obtained by the first acquisition means, for acquiring the first picture data, displaying means for displaying a picture derived from the first picture data obtained by the second acquisition means, specifying means for specifying the first URL associated with the picture data of the picture, among the pictures demonstrated on the display means, on which a cursor is located, and second supplying means for supplying the first URL, specified by the specifying means, to the second apparatus, connected by the connecting means.

The information processing apparatus may further comprise verifying means for verifying whether or not a command has been issued for enlarging the picture derived from the first picture data associated with the first URL specified by the specifying means, third acquisition means for transmitting, in case the verifying means has determined that the command has been issued for enlarging the picture, the first URL specified by the specifying means to the first apparatus, for obtaining a second URL associated with the first URL, and third supplying means for supplying the second URL, as obtained by the third acquisition means, to the second apparatus.

The connection by the connection means may be made via a third apparatus.

The display means may demonstrate a picture derived from the first picture data acquired by the second acquisition means, and further demonstrate the information for allowing a user to recognize a picture demonstrated on a display unit of the second apparatus.

In still another aspect, the present invention provides an information processing method comprising a first acquisition control step of controlling the acquisition of a first URL associated with first picture data supervised by a first apparatus, a connecting step of providing for connection to a second apparatus for enabling data exchange therewith, a first supplying step for supplying the first URL, the acquisition of which has been controlled by the processing of the first acquisition control step, to the second apparatus, connected by processing in the connecting step, a second acquisition control step of accessing the first apparatus, based on the first URL, obtained by the processing of the first acquisition control step, for controlling the acquisition of the first picture data, a display control step of controlling the display of a picture derived from the first picture data, the acquisition of which has been controlled by the processing of the second acquisition control step, a specifying step of specifying the first URL associated with the first picture data of the picture, among the pictures display-controlled by the processing by the display control step, on which a cursor is located, and a second supplying step of supplying the first URL, specified by the specifying step, to the second apparatus, connected by the processing of the connecting step.

In another aspect, the present invention provides a program for recording medium including a first acquisition control step of controlling the acquisition of a first URL associated with first picture data supervised by a first apparatus, a connecting step of providing for connection to a second apparatus for enabling data exchange therewith, a first supplying step for supplying the first URL, the acquisition of which has been controlled by the processing of the first acquisition control step, to the second apparatus, connected by processing in the connecting step, a second acquisition control step of accessing the first apparatus, based on the first URL, obtained by the processing of the first acquisition control step, for controlling the acquisition of the first picture data, a display control step of controlling the display of a picture derived from the first picture data, the acquisition of which has been controlled by the processing of the second acquisition control step, a specifying step of specifying the first URL associated with the first picture data of the picture, among the pictures display-controlled by the processing by the display control step, on which a cursor is located, and a second supplying step of supplying the first URL, specified by the specifying step, to the second apparatus, connected by the processing of the connecting step.

In yet another aspect, the present invention provides a program for having a computer execute a first acquisition control step of controlling the acquisition of a first URL associated with first picture data supervised by a first apparatus, a connecting step of providing for connection to a second apparatus for enabling data exchange therewith, a first supplying step for supplying the first URL, the acquisition of which has been controlled by the processing of the first acquisition control step, to the second apparatus, connected by processing in the connecting step, a second acquisition control step of accessing the first apparatus, based on the first URL, obtained by the processing of the first acquisition control step, for controlling the acquisition of the first picture data, a display control step of controlling the display of a picture derived from the first picture data, the acquisition of which has been controlled by the processing of the second acquisition control step, a specifying step of specifying the first URL associated with the first picture data of the picture, among the pictures display-controlled by the processing by the display control step, on which a cursor is located, and a second supplying step of supplying the first URL, specified by the specifying step, to the second apparatus, connected by the processing of the connecting step.

According to the present invention, the same picture is demonstrated on plural interconnected devices. In case plural pictures are demonstrated, the URL, associated with the picture, on which is located a cursor, is transmitted/received. The picture on which the cursor is to be located is determined by the URL so transmitted/received, such that the cursors of plural apparatus are located at all times on the same picture.

According to the present invention, it becomes possible for plural users to read e.g. a picture.

According to the present invention, plural readers may read the same album, catalog or moving pictures at different places at the same time point.

According to the present invention, a picture or a scene of interest may be indicated in real-time.

Moreover, according to the present invention, even in case a message is transmitted/received with the text or the voice, it is possible to prevent difference in recognition from occurring among the plural transmitting/receiving users to provide for smoother communication.

### BRIEF DESCRIPTION OF THE DRAWINGS

FIG. 1 shows the structure of an embodiment of an information processing system according to the present invention.

FIG. 2 illustrates data exchange within a system.

FIG. 3 shows an exemplary inner structure of a picture management server.

FIG. 4 shows an exemplary inner structure of a user identifying server.

FIG. 5 shows an exemplary inner structure of a PC.

FIG. 6 is a flowchart for illustrating the processing when the PC connects to the user identifying server.

FIGS. 7 to 11 show exemplary pictures demonstrated on a display.

FIG. 12 is a flowchart for illustrating the processing when plural users co-own an album.

FIG. 13 illustrates data stored in a memory unit of a picture management server.

FIGS. 14 to 16 show exemplary pictures demonstrated on the display.

FIG. 17 is a flowchart for illustrating the processing when plural users co-own an album.

FIG. 18 illustrates full picture movement.

FIG. 19 shows the structure of a mobile phone.

FIG. 20 shows an exemplary picture demonstrated on a liquid crystal display.

FIGS. 21 to 23 illustrate a virtual display area.

FIGS. 24 and 25 show exemplary pictures demonstrated on a display.

FIG. 26 shows an exemplary picture demonstrated on a liquid crystal display.

FIGS. 27 and 28 illustrate a virtual display area.

FIG. 29 shows an exemplary picture demonstrated on a display.

### DESCRIPTION OF PREFERRED EMBODIMENTS

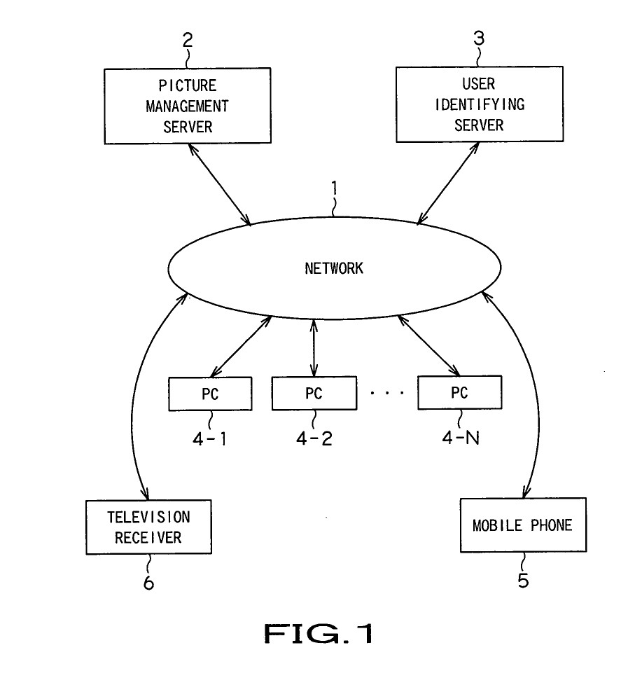

Referring to the drawings, certain preferred embodiments of the present invention are now explained. FIG. 1 shows the structure of an embodiment of an information processing system embodying the present invention. A network 1 is made up by the Internet and LAN (Local Area Network).

To the network 1 is connected a picture management server 2 responsible for picture management. The picture management server 2 manages a digitized album. There are plural pictures in the album for which a picture(s) may be added or deleted by the user who formulated the album. To the network 1 is also connected a user identifying server 3. The user identifying server 3 is a server used in specifying the server who reads the same album.

Plural personal computers (PCs) 4-1 to 4-N are user side computers. If, in the following explanation, the PCs 4-1 to 4-N need not be distinguished from one another, each of these PCs is simply referred to as PC 4. Although only one each of the picture management servers 2 and the user identifying servers 3 are shown in FIG. 1, plural picture management servers 2 and plural user identifying servers 3 are connected to the network 1.

Meanwhile, the picture management server 2 and the user identifying server 3 may be different servers, as shown in FIG. 1, or the respective functions may be provided by a sole server.

To the network 1 are also connected a television receiver 6 and a mobile phone 5 having the function of data exchange with other equipment over the network 1. Data exchange may be made among the equipment thus connected to the network 1.

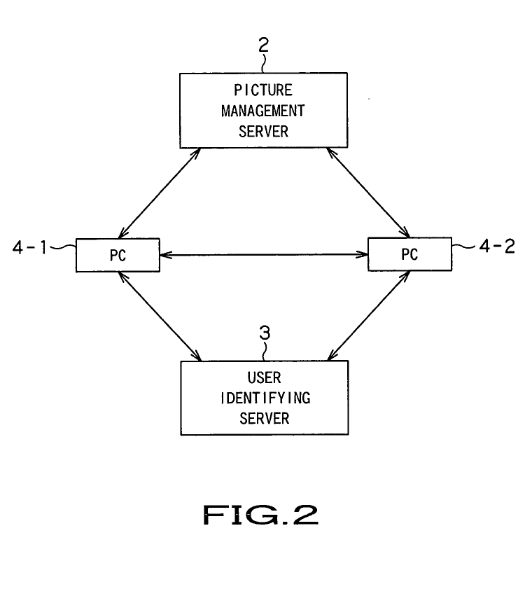

Here, a case in which the user of the PC 4-1 and the user of the PC 4-2 read the same album, as shown in FIG. 2. The PCs 4-1, 4-2 are able to acquire data of an album supervised by the picture management server 2. Moreover, the PCs 4-1 and 4-2 are enabled to communicate with each other either directly or via the user identifying server 3.

The PCs are here stated as being “enabled to communicate” because first of all the PC 4-1 and the PC 4-2 have the function (in the form of a device or software) capable of being connected to the picture management server 2 and the user identifying server 3 and are in a state of having concluded a contract with a predetermined service provider.

Second, the PCs are here stated as being “enabled to communicate” because an advance user registration, occasionally needed for receiving services rendered by the picture management server 2 and by the user identifying server 3, has already been finished and hence these services may now be accepted.

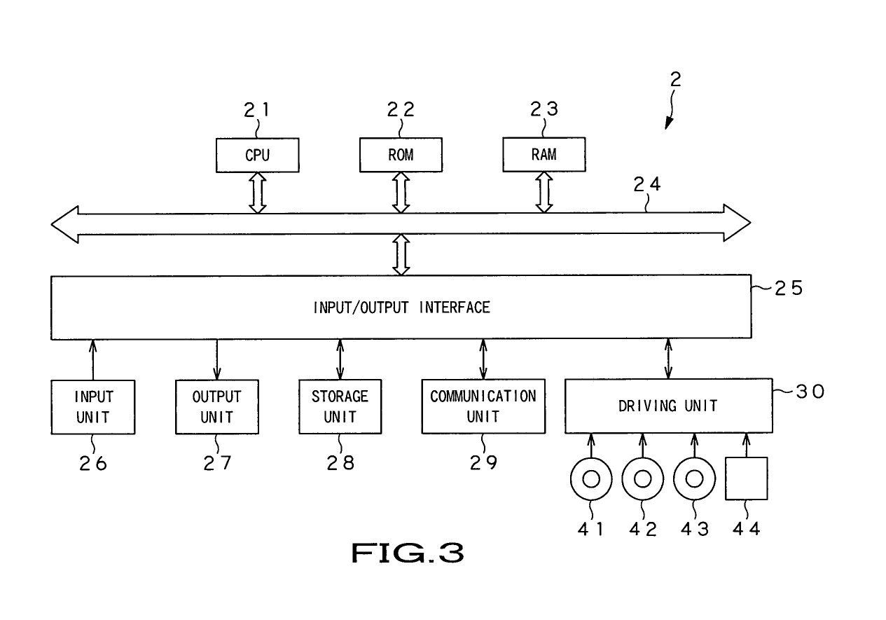

FIG. 3 shows an illustrative inner structure of the picture management server 2. This picture management server 2 may be in the form of e.g. a personal computer. The central processing unit (CPU) 21 executes various processing operations in accordance with the programs stored in a read-only memory (ROM) 2. In a random access memory (RAM) 23, there are stored data or programs required for the CPU 21 to execute various processing operations. To an input/output interface 25 is connected an input unit 26, formed by a keyboard or a mouse. The signals supplied at an input/output unit 26 are output to the CPU 21. To the input/output interface 25 is also connected an output unit 27 in the form of a display or a loudspeaker.

To the input/output interface 25 are also connected a storage unit 28, in the form of e.g. a hard disc, and a communication unit 29, adapted for exchanging data with other equipment over a network, such as the Internet. A drive 30 is used in reading out data from a recording medium, such as a magnetic disc 41, an optical disc 42, a magneto-optical disc 43 or a semiconductor memory 44 or in writing data therein.

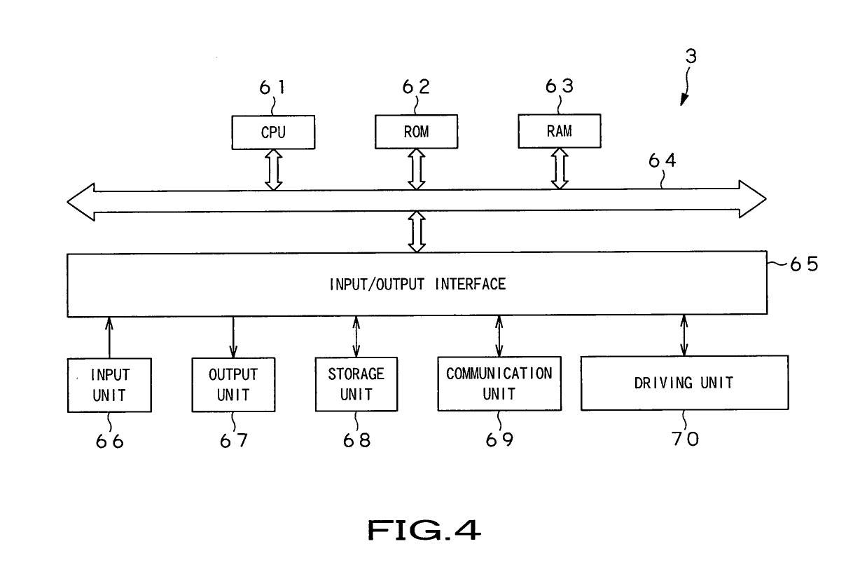

FIG. 4 shows an illustrative inner structure of the user identifying server 3. This user identifying server 3 is also formed by e.g. a personal computer. Since the basic structure of the user identifying server is the same as the picture management server 2, the corresponding description is omitted for simplicity.

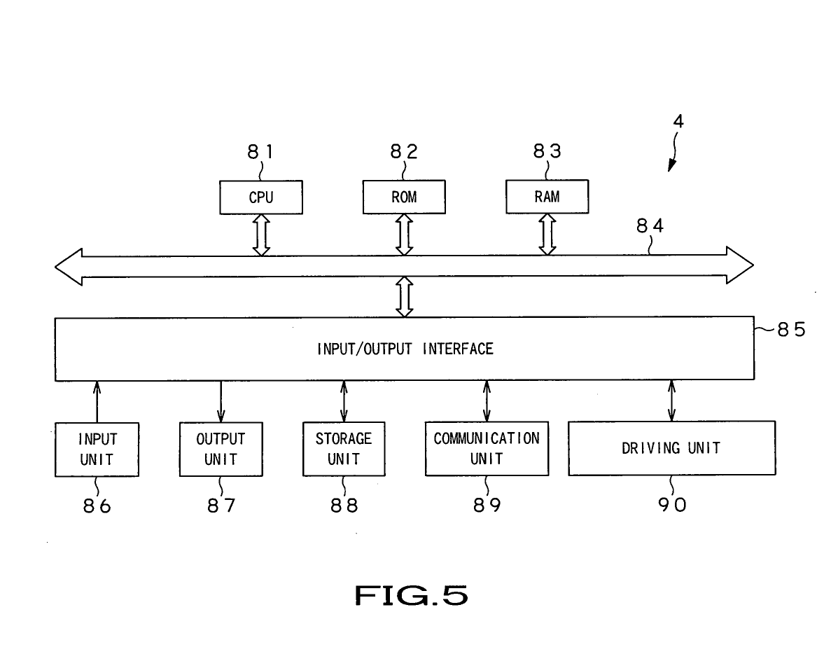

FIG. 5 shows an illustrative inner structure of the PC 4. Since the basic structure of the PC 4 is the same as the picture management server 2, the corresponding description is omitted for simplicity. Meanwhile, in the following explanation, the reference numerals shown in FIG. 5 are used for the reference numerals for the PC 4-1, while the reference numerals of FIG. 5 with prime (′) are used for the reference numerals for the PC 4-2.

The operation of the system shown in FIG. 2 is now explained. In the explanation, the personal computers PC 4-1 and PC 4-2 are assumed to possess approximately the same capability. By approximately the same capability is here meant the state in which, when 15 pictures are demonstrated on the display unit of the personal computer PC 4-1, 15 pictures are similarly demonstrated on the display unit of the personal computer PC 4-2.

The processing in which the user A of the PC 4-1 and the user B of the PC 4-2 simultaneously read the album, supervised by the picture management server 2, by their own PCs 4, is now explained.

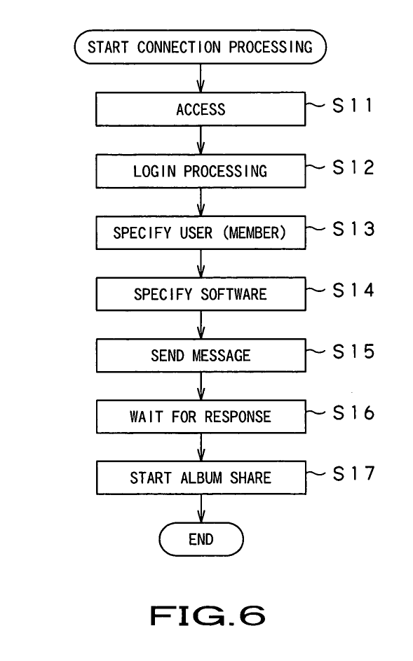

Referring to the flowchart of FIG. 6, the processing carried out by the PC 4-1 until the state in which PC 4-1 and the PC 4-2 are enabled to communicate with each other, that is, the state prior to the PCs simultaneously reading the album, is first explained. In the following explanation, it is assumed that the picture management server 2 is accessed after accessing the user identifying server 3. Conversely, the user identifying server 3 may be accessed after accessing the picture management server 2.

In a step S11, the PC 4-1 begins accessing the user identifying server 3 over the network 1. Of course, this accessing is initiated by the command from the user A. The accessing to the user identifying server 3 is carried out in a similar manner to connecting to the Internet. When the accessing to the user identifying server 3 comes to a close, data of the initial picture is transmitted from the user identifying server 3.

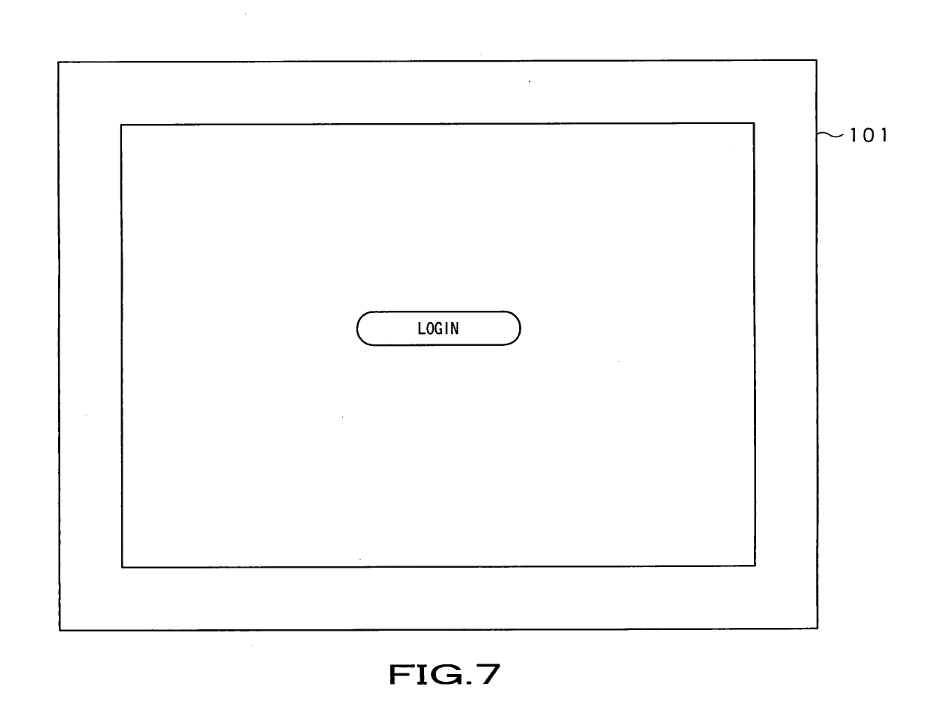

The PC 4-1 receives data from the user identifying server 3 by a communication unit 89 (FIG. 5). The CPU 81 causes the picture shown in FIG. 7 to be demonstrated on a display 101 by processing the received data. In the picture shown in FIG. 7, there is displayed a message for having the user recognize that the current state is as yet such a one in which the user cannot get the services by the user identifying server 3 (a state in which login has not been achieved).

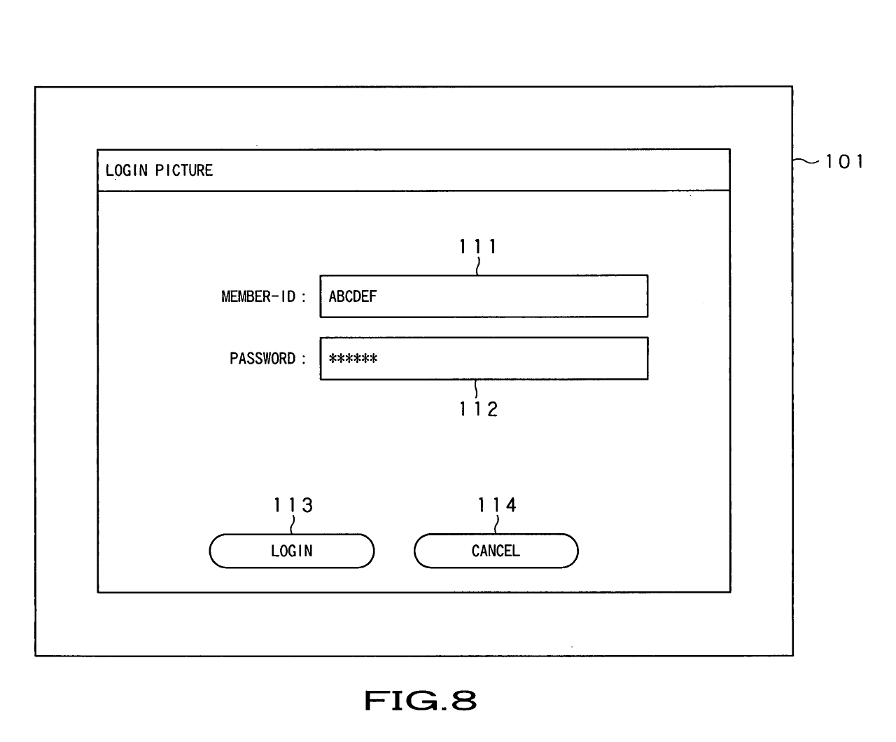

Next to this message, a picture shown in FIG. 8 is demonstrated on the display 101. The picture shown in FIG. 8 is such a one in which the user logs-in to accept the services rendered by the user identifying server 3. In the login picture, a column 111 for entering a user identifying ID (member ID) and a column 112 for entering a password are provided, as shown in FIG. 8.

The user identifying server 3 is able to identify the user uniquely based on the combination of the member ID and the password. Stated differently, the user identifying server 3 specifies the member (user) by the member ID and attests whether or not the user so specified is accessing the computer in person.

When executing the login processing by the information entered in the respective columns 111, 112, the user of the PC 4-1 manipulates a login button 113. When discontinuing the login processing, the user manipulates a cancellation button 114. In the following explanation, it is assumed that the member ID and the password have correctly been entered and the login button 113 has been actuated.

If the member ID and the password have not been entered correctly and the login button 113 has been actuated, the user identifying server 3 is unable to identify the user uniquely, so that the login is not allowed. In case the login has not been allowed, a message indicating that effect is sent to the user and demonstrated on a display 101.

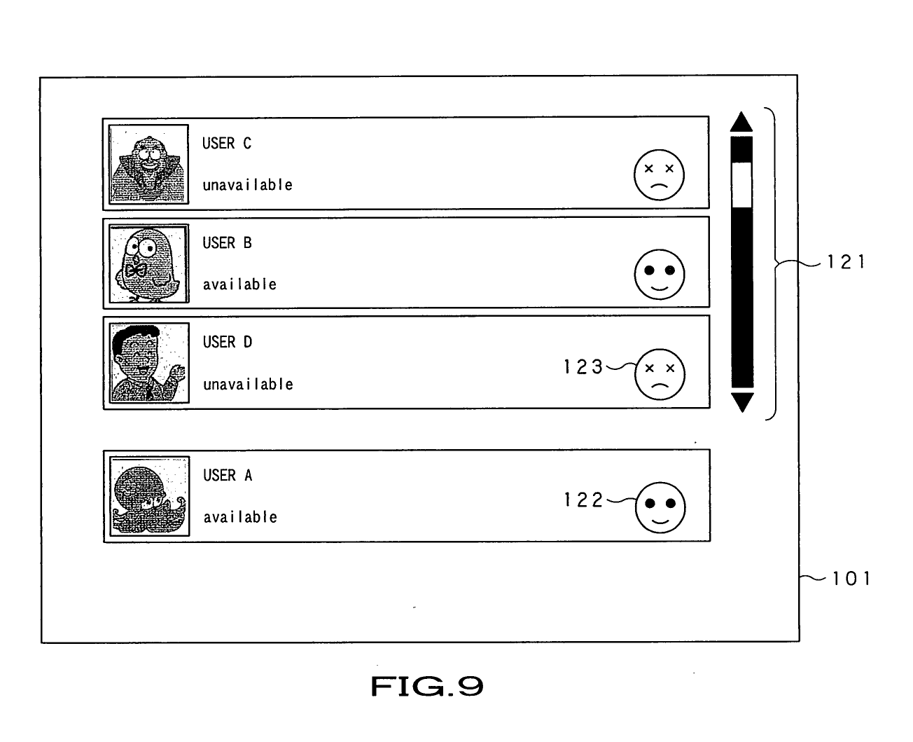

Returning to the explanation of the flowchart of FIG. 6, the figure shown in FIG. 8 is referenced in a step S12, and the preset information is entered to perform the login processing. If, by this processing, the login is made, the picture shown in FIG. 9 is demonstrated on the display 101 of the PC 4-1 of the user who has logged in.

A member display unit 121 is provided on an upper portion of the picture shown in FIG. 9. In this member display unit 121, a list of users, in which the user A has been registered as a member, is displayed. Here, an area in which the information as a user is displayed is stated as a block. In the picture shown in FIG. 9, three blocks are demonstrated in the member display unit 121.

The user A executes the processing of pre-registering a user(s) with whom the user A is desirous to read the album simultaneously and a user(s) with whom the user A is desirous to exchange messages in real-time. The information of the pre-registered users is demonstrated as members in the respective blocks of the member display unit 121.

In the picture shown in FIG. 9, three users, namely the users B to D, are demonstrated in the member display unit 121. Other users (blocks of the other users) may be demonstrated by actuating a scroll bar provided on the right hand side of the member display unit 121.

On a lower portion of the member display unit 121, there is displayed the own information. The information displayed in the respective blocks as the information of the respective members (users) including the user A includes, first of all, the user's names. On the left hand side of the user's names, there are displayed pictures which the users themselves or the user A have set as the pictures representing the users themselves or the user A. These pictures are the users' face photos or characters.

Below the users' names, there are indications “available” or “unavailable”. These indications are letter strings displayed in association with connection marks 122 or non-connection marks 123. The connection mark is displayed in the block of the user who has logged-in in the user identifying server 3 and who is able to communicate, such that, when the connection mark 122 is demonstrated, the indication “available” is made.

Conversely, the non-connection marks 123 is displayed in the block of the user who has not logged-in in the user identifying server 3 and who is unable to communicate, such that, when the non-connection mark 122 is demonstrated, the indication “unavailable” is made.

When the picture shown in FIG. 9 is demonstrated on the display 101 of the PC 4-1, the user A specifies the user(s) (member(s)) with whom the user A is desirous to read the album. In specifying the user(s), the user A selects the block(s) of the user(s) for whom the connection mark(s) 122 are displayed. The user(s) of the block (s), for whom the non-connection mark(s) 123 are displayed, are unable to communicate, as, described above, and hence cannot be selected.

The user A manipulates a mouse, not shown, or a keyboard, also not shown, operating as an input unit 86 (FIG. 5), to select the desired member from the member display unit 121. Referring to FIG. 9, the block where there is positioned a cursor is shown shaded or is colored differently from the other blocks, for distinction from the other blocks.

In the picture shown in FIG. 9, a cursor is located in the block associated with the user B, so that the block is of a color different from the color of the other blocks.

In the picture shown in FIG. 9, the connection mark 122 is displayed in the block of the user B. Thus, the user A is able to select the user B as a member with whom the user A is to read the album. So, the user A specifies the user B as the member with whom the user A is to read the album. The CPU 81 of the PC 4-1 suitably verifies and processes these operations by the user A to execute the processing concerning the user (member) identification in a step S13.

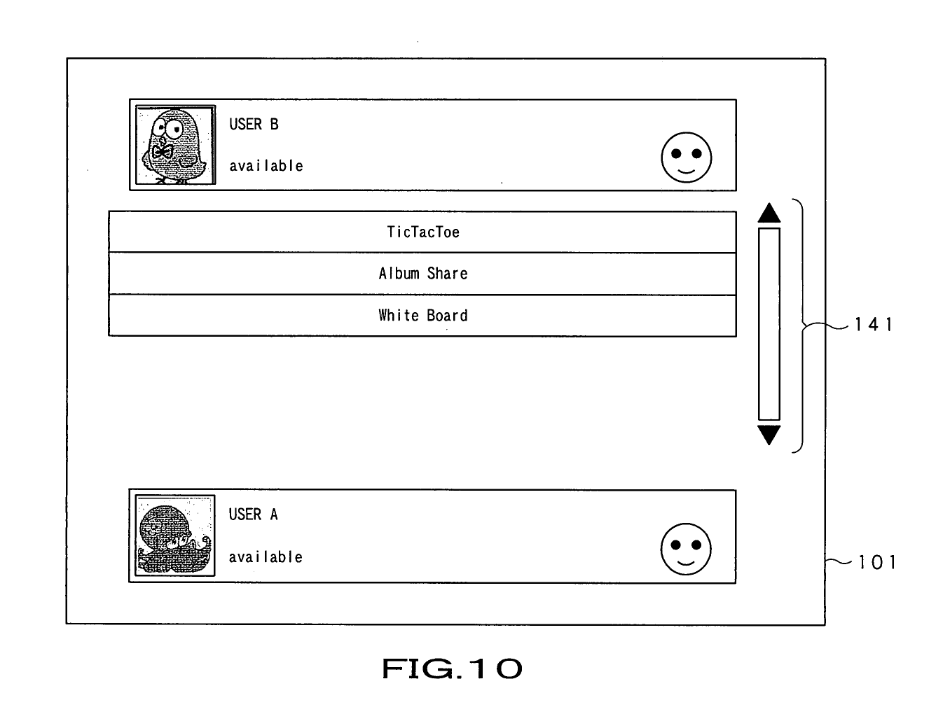

In case the user A is desirous to read the album with the user B, the user A causes movement of the cursor to the block of the user B. When the movement has been done, the user A clicks a button (for example, a button on the right side of the mouse, not shown). On recognizing that such click has been made, the CPU 4 of the PC 4-1 causes the picture shown in FIG. 10 to be demonstrated on the display 101.

The picture shown in FIG. 10 is now explained. In a picture shown in FIG. 10, there is demonstrated a software name display unit 141. In this software name display unit 141, there are demonstrated the names of the software owned in common by the user A (PC 4-1) and the user B (PC 4-2) and which can be used in the state of logging into the user identifying server 3 (FIG. 2). The information on the software names, demonstrated in the software name display unit 141, may be stored by the PC 4-1 itself, or may be managed by the user identifying server 2 so as to be supplied as necessary to the PC 4-1.

In the case of FIG. 10, the names of the three software “Tic Tac Toe”, “Album Share” and “White Board” are shown displayed. In the following explanation, it is assumed that the “Album Share”, sometimes referred to below as album share, is a software booted when the users simultaneously read the album, and that this album share is selected.

In selecting the software name, which the user S desires to read simultaneously with the user B, from the software names demonstrated on the software name display unit 141, the user A manipulates the mouse or the keyboard, not shown, as in identifying the member as described above, to cause the cursor to be moved to a position on the desired software name. In the case of a picture shown in FIG. 10, the cursor has been moved to s position on the software name “Album Share” in the software name display unit 141. If, in this state, the user manipulates e.g. a mouse, it is verified that the software has been selected.

The display control of software names on the software name display unit 141, or the display control attendant on cursor movement, are carried out by the CPU 81 as the control of step S14.

If, in this case, the album share is selected as the software name, processing transfers to a step S15. In this step S15, the message is transmitted. This message is transmitted to the member identified in the step S13 (more precisely, to the PC 4 of the member). In this case, the message is sent to the PC 4-2 of the user B.

The contents of the message are the message of invitation from the user A prompting the identified member to perform the processing by the software specified in the step S14, here the album share, together with the user A. In this case, the contents of the message are the invitation from the user A to the specified member prompting the member to read the album (picture) together with the user A.

On receipt of such invitation, a message reading, for example: “The user A is inviting you to read AlbumShare. Do you accept it?” is demonstrated on the display 101 of the user B.

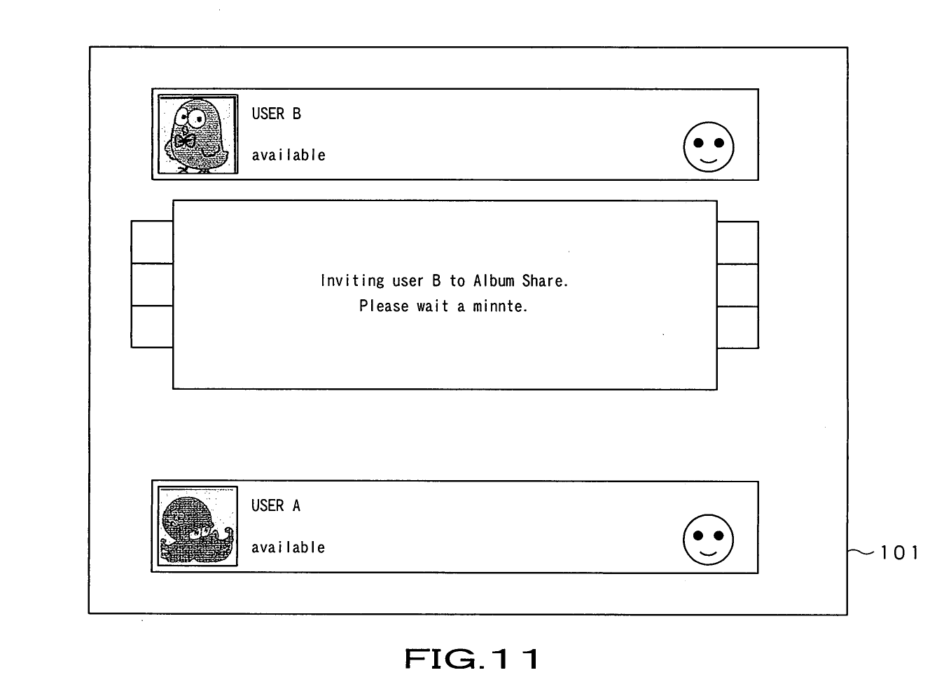

As such message is being transmitted, a message such as is shown in FIG. 11 is demonstrated on the display 101 of the PC 4-1 of the user A. The message shown in FIG. 11 reads, for example: “Now, inviting the user B to AlbumShare. Please wait a moment”.

After sending the message to the PC 4-2 of the user B, the PC 4-1 is in a state of waiting for a response to the message (step S16). On receipt of the response from the user B to the message, the processing which is in keeping with the response is executed. The contents of the response reside in accepting or not accepting the invitation.

On receipt of the response for accepting the invitation, the processing by the software named AlbumShare is started as the processing in a step S17. The software named AlbumShare is sometimes referred to below simply as the album share.

In case of receipt of the reply that the invitation is not accepted, the processing by the album share is not started, although this case is not shown. Also, in such case, a message indicating such effect, for example, a message reading: “the invitation was not accepted”, is demonstrated on the display 101 of the user A.

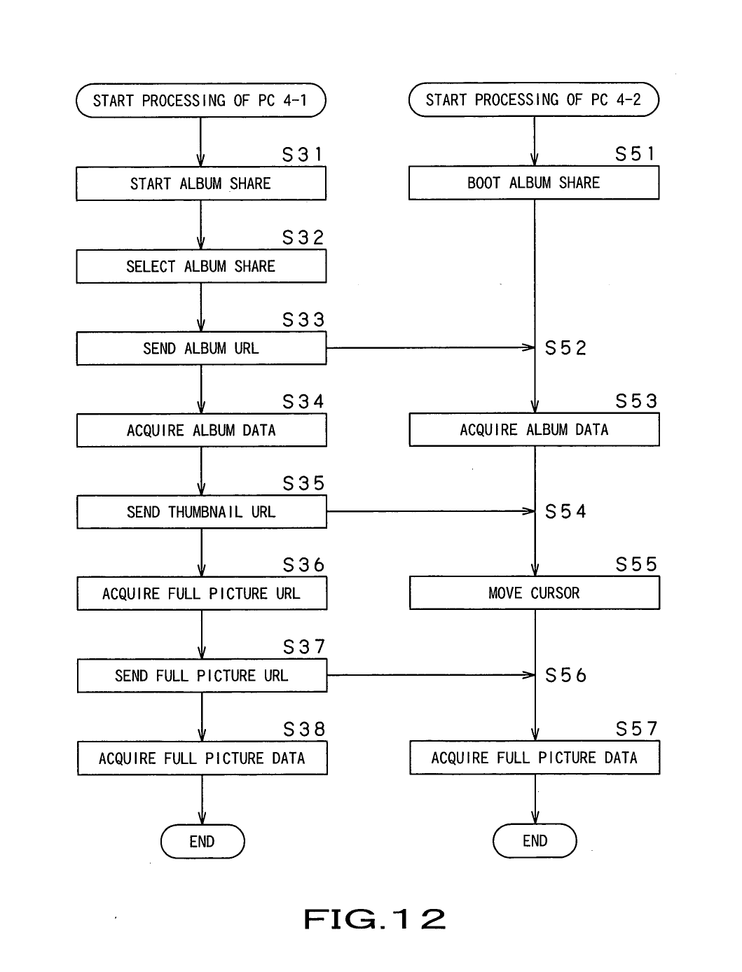

In the ensuing explanation, it is assumed that the invitation has been accepted. If, in this case, the user B has consented to read the album (to co-own the album) simultaneously, the album share is booted on the PC 4-1 of the user A and on the PC 4-2 of the user B. Referring to the flowchart of FIG. 12, the operation taking place between the PC 4-1 and the PC -2, for whom the album share has been booted, is explained.

Although the operation carried out between the PC 4-1 and the PC 4-2 is explained, only for convenience, if the user has selected plural users (members) in the step S13 (FIG. 6), the PCs 4 of the selected members basically perform the same operations as those performed by the PC 4-2, among the operations which are hereinafter explained.

In addition, although the flowchart shown in FIG. 12 is explained as if the PC 4-1 has the initiative, there is no master/slave relationship between the PC 4-1 and the PC 4-2, and the rights owned by these PCs are equal, such that the operation carried out by the user 4-1 is basically the operation that can be carried out by the PC 4-2.

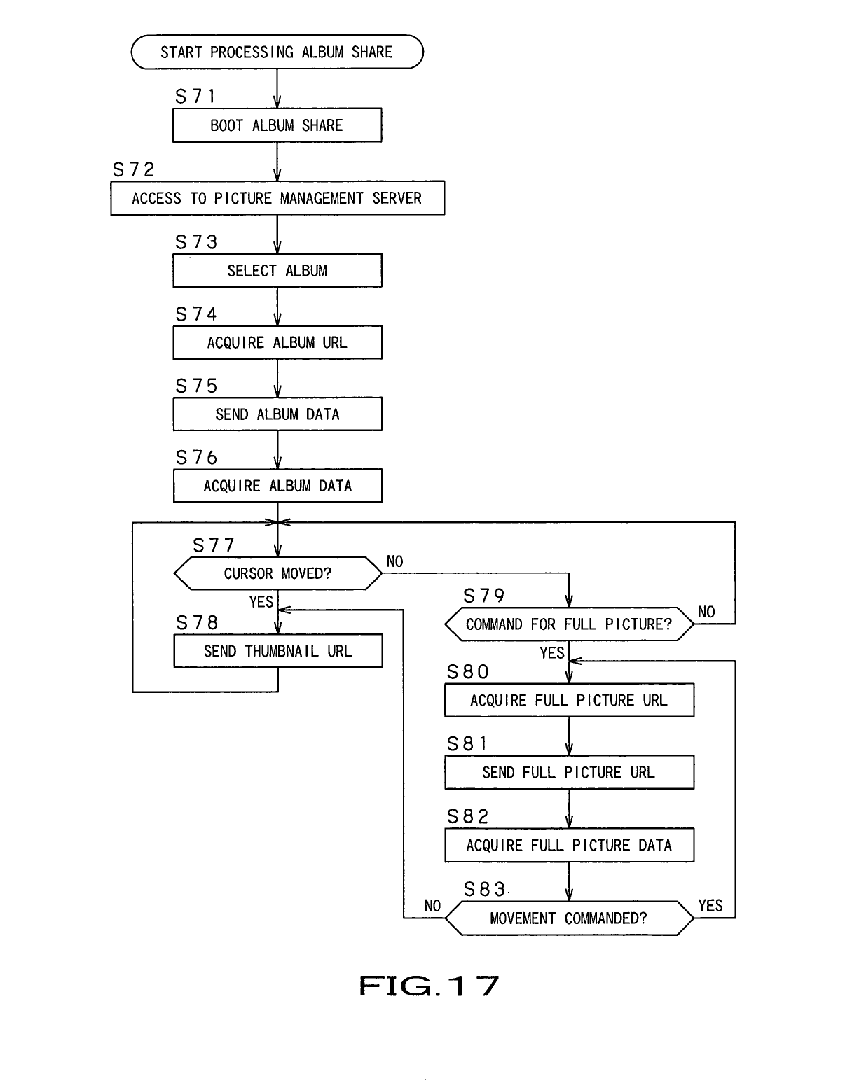

Moreover, the explanation on the processing in accordance with the flowchart of FIG. 12 is that on the gross processing carried out between the PC 4-1 and the PC 4-2. The detailed processing on the PC 4-1 is explained later by referring to the flowchart of FIG. 17.

In a step S31, the CPU 81 of the PC 4-1 (FIG. 5) reads out and boots the album share stored in a storage unit 88. The data of the album share itself may not be stored by the PC 4-1 itself, but may be supplied as necessary from the picture management server 2 or the user identifying server 3.

In similar manner, the album share is booted in a step S51 on the PC 4-2. If the album share has been booted on both the PC 4-1 and on the PC 4-2, the album begins to be co-owned. If such album co-owning begins, the following data:

<query xmls=‘urn:schema-sssy-com.albumshare:service’>

<start/>

</querry>

is sent, as a notification for start of an album co-owning session, from the PC 4-1 to the PC 4-2.

The album co-owning begins with the transmission of the notification.

When the album share is started on both the PC 4-1 and the PC 4-2, the PC 4-1 executes the processing for album selection in a step S32.

For example, if the user A has registered plural albums on the picture management server 2, the user A has to decide which one of the albums is to be read simultaneously with the user B. In case the user A has not registered plural albums in the picture management server 2, the processing in the step S32 can be omitted. Or, if the user A has registered plural albums in the picture management server 2, a preset album may be furnished, as a default, without the user A or the user B performing the processing for album selection.

If, in the step S32, album selection is carried out on the CP 4-1 of the user A, the URL (Uniform Resource Locator) allocated to the album, referred to below as album URL, is sent to the PC 4-2 of the user B. At a time point the album has been selected, the so selected album URL is sent from the image management server 2, so that the album URL, thus supplied, is sent to the PC 4-2.

The transmission/receipt of the URL, as described above, and as will now be explained, may be carried out through the user identifying server 3, or may be directly carried out between the PC 4-1 and the PC 4-2. As for the processing through the user identifying server 3, the information for data exchange basically has been acquired by the PC 4-1 and the PC 4-2, at a time point as from the time the user co-owning the album (PC 4) has been selected or specified. Thus, data exchange may directly be performed without the intermediary of the user identifying server 3.

The picture management server 2 allocates the URL to each album and supervises the so allocated URL. Although it is explained here that the URL is allocated to each album, it is also possible to allocate only the album name to each album, or to set only the album name by the user, such that the album is supervised by the album name.

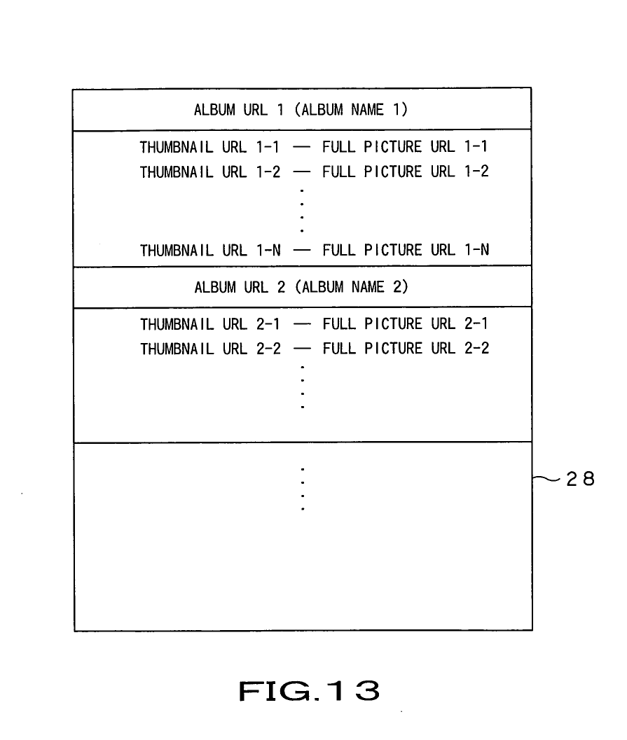

FIG. 13 shows the structure of data stored in the storage unit 28 (FIG. 3) of the picture management server 2 (FIG. 3). A sole album URL (album name) is allocated to a sole album. In FIG. 13, the album URL is e.g. an album URL 1 or an album URL 2.

The album URL 1 is associated with plural thumbnails URL 1-1 to URL 1-N. These thumbnails URL 1-1 to URL 1-N are URLs allocated from one picture forming an album indicated by the album URL 1 to another. The thumbnails URL 1-1 to URL 1-N are associated with full pictures URL 1-1 to URL 1-N.

The thumbnails URL 1-1 to URL 1-N are URLs allocated to respective plural pictures demonstrated simultaneously on the user side display device. The full pictures URL 1-1 to URL 1-N are URLs allocated to the pictures when only one of the pictures is demonstrated to an enlarged scale on the user side display device. The pictures indicated by the thumbnail pictures URL 1-1 to URL 1-N and the pictures indicated by the full pictures URL 1-1 to URL 1-N associated therewith simply differ as to the display size and are pictures of the same picture pattern.

In this manner, a sole album URL (album name) is allocated to a sole album and plural thumbnail URLs are associated with the sole album URL, that is, plural URLs may be uniquely specified by the sole album URL, and a sole thumbnail URL is associated with a sole full picture. It is these data pertinent to the album that are stored in the storage unit 28.

Returning to the explanation of the flowchart shown in FIG. 12, the album URL, sent in the step S33 from the PC 4-1 to the PC 4-2, is received by the PC 4-2 in a step S52. Based on the album URL, received in the step S52, the PC 4-2 connects to the picture management server 2 to acquire the album data indicated by the received album URL.

In similar manner, the PC 4-1 connects to the picture management server 2 to acquire the album data indicated by the so acquired album URL as the processing of step S34.

The album data acquired by the PC 4-1 or PC 4-2, that is, the album data transmitted from the picture management server 2, is the picture data associated with the thumbnails URL 1-1 to URL 1-N and picture data associated with these URLs. It is also possible to arrange so that the thumbnails URL 1-1 to URL 1-N are acquired first and so that the picture data are acquired based on the so acquired thumbnails URL 1-1 to URL 1-N.

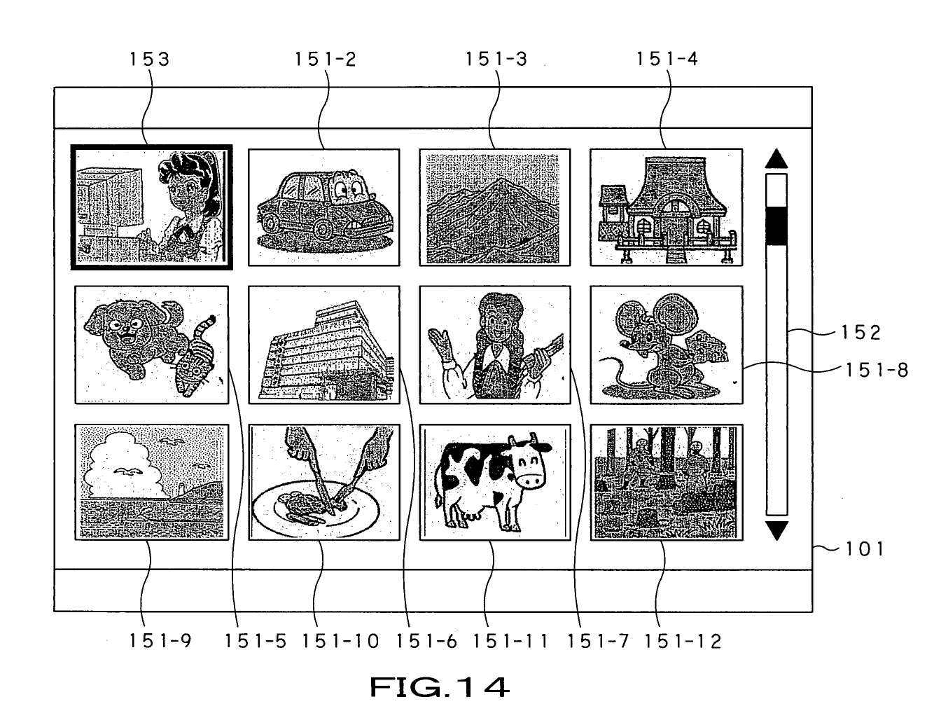

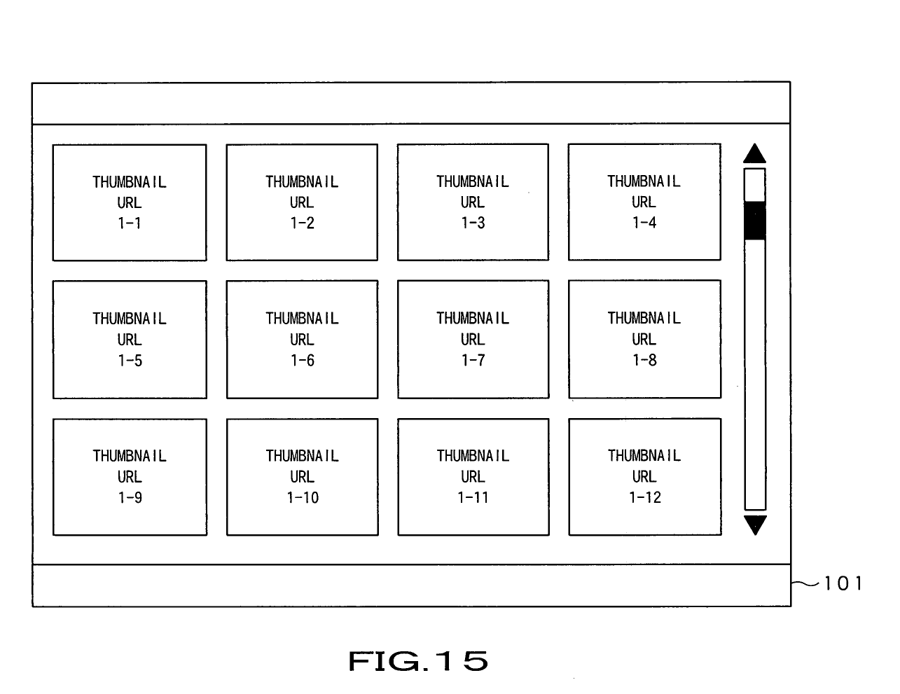

FIG. 14 shows an exemplary picture demonstrated on the display 101 of the PC 4-1 of the user A when the acquisition of the album data comes to a close and the album data so acquired are processed. A similar picture is demonstrated on a display 101′ of the PC 4-2 of the user B.

In the exemplary picture, shown in FIG. 14, there is shown a state in which 12 thumbnail pictures of thumbnail pictures 151-1 to 151-12 are demonstrated on the display 101. If there is a thumbnail picture, not displayed, a scroll bar 152 is displayed on e.g. the right side on the picture. By the user manipulating the scroll bar 152, the thumbnail picture, not displayed, may be demonstrated on the display 101 and read.

These thumbnail pictures are associated with the thumbnails URL 1-1 to 1-N. For example, the thumbnail picture 151-1 is associated with the thumbnail URL 1-1. The other thumbnails are similarly associated with the thumbnail URL. Stated differently, if the thumbnail URL is known, it is possible to identify the associated thumbnail picture (to acquire picture data).

By such picture being demonstrated on the display 101 of the PC 4-1 and on the display 101′ of the PC 4-2 simultaneously, the users A and B are simultaneously reading the same album on different sites.

Referring to FIG. 14, a cursor 153 is located on the thumbnail picture 151-1. The thumbnail picture, on which is located the cursor 153, is displayed so that this thumbnail picture may be distinguished from the other thumbnail pictures.

This cursor 153 may be moved between neighboring thumbnails 151 by the user A manipulating the input unit 86 (FIG. 5) composed of e.g. a mouse or a keyboard. When the user A moves the cursor 153, the thumbnail URL is sent to the PC 4-2, as the processing for the step S35, in keeping up with the cursor movement.

That is, when first the cursor 153 is moved, this movement is detected. The thumbnail URL associated with the thumbnail picture as the destination of movement is identified. The so identified thumbnail URL is sent to the PC 4-2. When the cursor 153 is moved from the state shown in FIG. 14, that is, from the state in which the cursor is located on the thumbnail picture 151-1 to a position on the thumbnail 151-3, the thumbnail URL 1-3 is sent to the PC 4-2.

Meanwhile, when the cursor 153 is moved from the state it is located on the thumbnail picture 151-1 to the state it is located on the thumbnail picture 151-3, the cursor traverses the thumbnail picture 151-2. A thumbnail URL corresponding to the thumbnail picture 151-2 may also be transmitted at a time point the cursor traverses the thumbnail picture 151-2. In this case, the thumbnail URL is sent each time it is detected that the cursor 153 has been moved to the thumbnail pictures disposed on upper and lower and left and right sides.

Or, when it is determined that the movement of the cursor 153 has come to a standstill, only the thumbnail URL of the thumbnail picture determined to have come to a standstill may be transmitted. It is when the cursor 153 is determined to have been stopped for a preset time period on a preset thumbnail picture that the movement of the cursor 153 is determined to have come to a standstill.

The PC 4-2 in a step 54 receives the thumbnail URL transmitted from the PC 4-1. The PC 4-2 performs, as the processing in a step S55, such a processing in which a cursor 153′ is located on the thumbnail picture corresponding to the received thumbnail URL.

By transmitting/receiving the thumbnail URL in this manner, the thumbnail picture may uniquely be specified to specify the thumbnail picture on which to locate the cursor 153 (153′). Moreover, since the thumbnail picture, on which the cursor 153 (153′) is located, may uniquely be determined, the cursor 153 (153′) may be moved n real-time to the same position (to the location on the same thumbnail picture) on both pictures of the PC 4-1 and PC 4-2.

The processing is carried out on the PC 4-1 and on the PC 4-2 each time the cursor 153 (153′) is moved. Although the explanation has been made as if the PC 4-1 has the initiative, there is no master/slave relationship between the PC 4-1 and the PC 4-2, as stated previously, so that, when the cursor 153′ is moved on the PC 4-2 side, the thumbnail URL is sent from the PC 4-2 to the PC 4-1, in keeping up with the cursor movement, while the cursor 153 is positioned on the thumbnail picture corresponding to the so transmitted thumbnail URL on the PC 4-1.

In a step S36, the full picture URL is acquired on the PC 4-1. This processing is initiated if, in case the cursor 153 is located on the preset thumbnail, it is verified that the user A has performed a preset processing, such as mouse double-click, In the album share, the preset operation, such as the mouse double click, is presumed to be the operation when it has been desired to switch the display of the thumbnail pictures to the full-size display of solely a picture of the thumbnail pictures (full picture display).

When the user A has performed a preset operation, such that display of a full picture is commanded, the thumbnail URL of the thumbnail picture, the full picture of which has been commanded to be displayed, is sent to the picture management server 2. The picture management server 2 sends to the PC 4-1 the full picture URL corresponding to the received thumbnail URL. By this processing, the PC 4-1 acquires the full picture URL.

In a step S37, the so acquired full picture URL is transmitted from the PC 4-1 to the PC 4-2. As the full picture URL is sent in this manner to the PC-2, the PC 4-1 acquires picture data of the full picture from the picture management server 2, based on the acquired full picture URL.

In similar manner, the PC 4-2 in a step S56 receives the full picture URL, sent from the PC 4-1 and, based on the so received full picture URL, in a step S57 acquires picture data of the full picture from the picture management server 2.

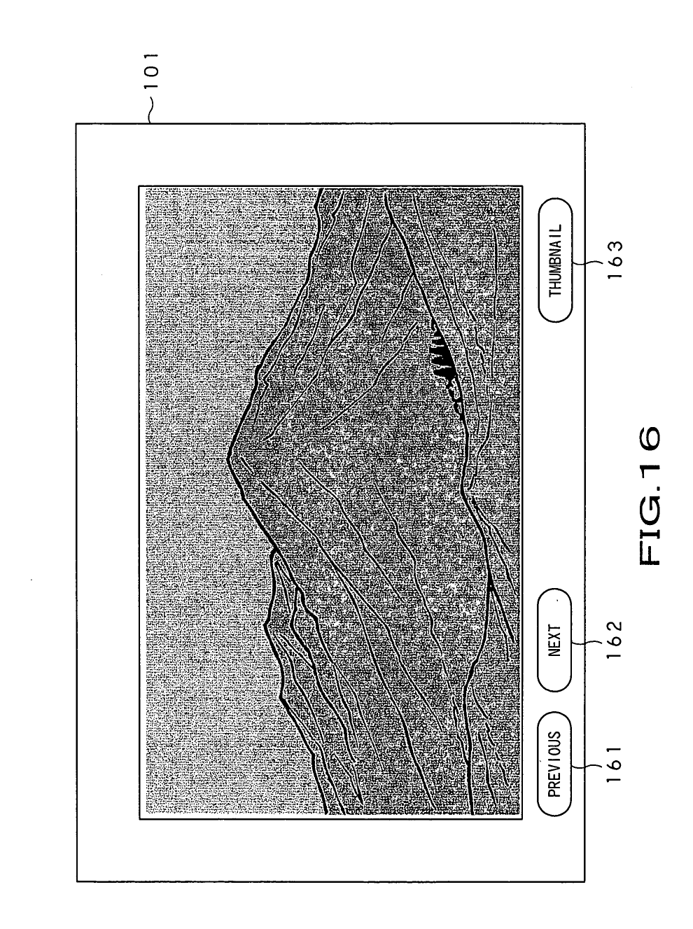

Thus, in case the full picture display is commanded, the full picture URL acquired by the PC 4-1 is sent to the PC 4-2, such that the PC 4-1 and the PC 4-2 acquire picture data of the full picture from the picture management server 2, based on the full picture URL acquired by each of the PC 4-1 and PC 4-2. FIG. 16 shows pictures demonstrated by this processing on the display 101 of the PC 4-1 and on the display 101′ of the PC 4-2.

Reference to the pictures shown in FIGS. 16 and 14 indicates that, since switching from the picture shown in FIG. 14 to full picture display of the thumbnail picture 151-3 has been commanded, the demonstration on the display 101 has been switched to the full picture of the thumbnail picture 151-3 shown in FIG. 6.

When the full picture has been commanded, both the user A and the user B are able to read the same picture as a full picture.

Referring to the flowchart of FIG. 17, the processing by the PC 4-1, included in the processing explained with reference to FIG. 12, is now explained in detail. In a step S71, the album share is booted on the PC 4-1. The program of the album share is stored in e.g. the storage unit 88 (FIG. 5). This program is read out and extended in the RAM 83 to boot the album share.

When the album share is booted, access to the picture management server 2 is started in a step S72. This access is achieved in such a manner that, if, in order to accept the services rendered by the picture management server 2, the login processing, such as inputting the user ID or the password, is necessary, this processing of inputting the user ID or the password is carried out on the PC 4-1, and the input information is transmitted to the picture management server 2, which picture management server executes the processing of user authentication based on the received information.

In case arrangement is made on the user B of the PC 4-2 so that the services rendered by the picture management server 2 cannot be accepted except if the login processing is similarly performed, the processing similar to that performed on the PC 4-1 is carried out on the PC 4-2.

In the foregoing explanation, the picture management server 2 is accessed after accessing the user identifying server 3. The sequence may, however, be reversed. In the above embodiment, the member(s) with whom the album is read together is selected, and the album share is booted, after which the picture management server 2 is accessed. This sequence may also be reversed.

For example, processing may be carried out in such a sequence that the user A reading the album supervised by the picture management server 2 feels inclined to read the album with the user B and invites the user B to read the album together (processing of the steps S13 to S17 of FIG. 6).

The timing of accessing the picture management server 2, the timing of accessing the user identifying server 3, or the timing of booting the album share, for example, may be as desired by the user A, such that the above-described embodiment is not limitative.

For explanation sake, it is assumed that the album share is booted in the step S71 and that access to the picture management server 2 is started in the step S72.

If, in the step S72, access to the picture management server 2 comes to a close, processing transfers to a step S73 to execute the processing of album selection. If there are plural albums the management of which the user A entrusts to the picture management server 2, data pertinent to the album names is transmitted from the picture management server 2.

On receipt of the data pertinent to the album names, transmitted from the picture management server 2, the album names are demonstrated on the display 101, based on the data. A sole album name is selected by the user A from the album names displayed on the display 101. When the album name is selected, the album URL, corresponding to the selected album name, is acquired in the step S74.

This acquisition of the album URL may be made in such a manner that, when the album name is sent from the picture management server 2, the album name thus sent is correlated with the album URL and, when the album name is selected, the album URL associated with the album name is determined on the PC 4-1.

Alternatively, the arrangement may be made so that, when the album name is sent from the picture management server 2, only the data on the album name is sent, and so that, when the album name is selected, the data indicating the selected album name is transmitted to the picture management server 2, which picture management server 2 then determines the album URL from the received data to transmit the so determined album URL to the PC 4-1.

The PC 4-1 may acquire the album URL by any of the techniques described above. However, in the step S74, the PC 4-1 acquires the album URL corresponding to the album name selected by the user. In a step S75, the PC 4-1 transmits the acquired album URL to the PC 4-2. The data of the album URL, transmitted in this step S75 from the PC 4-1 to the PC 4-2, are as shown below:

<query xmls=‘urn: schema-sssy.-com.albumshare service’>

<album name =‘album name’count=‘number of sheets’>

<url>URL of the first picture (thumbnail URL) </url>

<url>URL of the second picture (thumbnail URL) </url>

<url>URL of the third picture (thumbnail URL) </url>

</album>

The data of the album URL (data supervised as it is correlated with the album name) includes plural thumbnail URLs specified by the album URL.

The data including the thumbnail URL is transmitted from the PC 4-1 to the PC 4-2. As the data is transmitted in this manner, the album data are acquired in a step S76. It is assumed that the album data are a set of thumbnail pictures included in the album.

The PC 4-1 accesses the picture management server 2, based on the plural thumbnail URLs, included in the data transmitted to the PC 4-2, and acquires picture data correlated with the respective thumbnail URLs. By acquiring picture data from the picture management server 2, and processing the so acquired picture data, plural thumbnail pictures, shown in FIG. 14, are demonstrated on the display 101 of PC 4-1.

On the PC 4-2, picture data of the thumbnail picture are similarly acquired from the picture management server 2, based on data including plural thumbnail URLs from the PC 4-1. Thus, the same picture is demonstrated on the PC 4-1 and on the PC 4-2.

In case the user A has selected not only the user B but also other member(s), such as user C, as members co-owning the album, the processing of transmission of the album URL in the step S75 is also transmitted to the PC 4 of the user C and to the PC(s) 4 of the other member(s). By transmitting the album URL simultaneously to the PC(s) 4 of the plural users, the same album is displayed on the display of the PC 4 of each user to whom has been sent the album URL, such that the same album may be read simultaneously by the plural users.

If, by the acquisition in the step S76 of the picture data of the thumbnail picture, the picture shown in FIG. 14 is demonstrated on the display 101 of the PC 4-1 of the user A, the user A reads the picture. The user A then moves the cursor 153 (see FIG. 14) in order to let the user B view this picture, or in order to select the picture which is to be the one full-size picture.

If the cursor 153 is moved by the user A, the cursor 153′ is similarly moved on the picture the user B is viewing, so that it is possible that the picture of interest for the user A may be recognized by the user B as well. In addition to the movement of the cursor 153, the message by the text and the speech may also be transmitted to the user B.

For example, the user identifying server 3 may be provided with the function of the members reciprocally transmitting/receiving messages in a simplified fashion. These messages are routinely termed ‘instant messages’. In the present case, the users A and B may exchange messages, with the aid of this function.

There is also the function of call functions over the network 1, such as the Internet, e.g. the VoIP (Voice over Internet Protocol). In the present case, the users A and B may exchange messages by voice with the aid of this function.

Returning to the flowchart of FIG. 17, it is checked whether or not, in a step S77, the movement of the cursor 153 has been commanded. When it is verified that the movement of the cursor 153 has been commanded, processing transfers to a step S78. In this step S78, the thumbnail URL of the thumbnail picture, in which is positioned the cursor 153, is transmitted from the PC 4-1 to the PC 4-2.

On the PC 4-2, the cursor 153′ is moved to a thumbnail picture, corresponding to the transmitted thumbnail URL. By this exchange of the thumbnail URL and by positioning the cursor 153 on the thumbnail picture corresponding to the thumbnail URL, it is possible in this case for both the user A and the user B to direct attention to the same picture.

In the present case, the thumbnail URL is exchanged in this manner as the position information for the cursor 153. Supposing that the information on the coordinates of the current position of the cursor 153 is exchanged as the position information for the cursor 153, and that display units having different coordinate systems are used as display devices, as when one of the display unit is that of the PC 4 an the other is that of a mobile phone 5, there is the possibility that the cursors 153 on the two display units are located at different positions.

That is, if the information of the coordinates of the current position of the cursor 153 is exchanged as the position information of the cursor 153, the cursor 153 is not necessarily located on the same thumbnail picture. However, by exchanging the thumbnail URL, as in the present embodiment, the cursor 153 can be located at all times on the same thumbnail picture, without dependency on which sort of the display device is used.

The above is the manner of processing on the movement of the cursor 153.

On the other hand, if it is determined in the step S77 that the command for movement of the cursor 153 has not been made, processing transfers to a step S79 where it is determined whether or not a command for a full picture has been made. If it is determined in the step S79 that the command for the full picture has been made, processing transfers to a step S80.

In the step S80, the full picture URL is acquired. First, in case it is determined that the user A has performed a preset operation, such as e.g. mouse double click, by way of a command for displaying a full picture, the thumbnail URL of the thumbnail picture, for which the mouse has been double-clicked, is acquired.

This acquisition of the thumbnail URL is made by reading out (specifying) the thumbnail URL, being supervised, because the thumbnail URL has already been supervised by the PC 4-1 in association with the thumbnail picture.

However, since the thumbnail URL of the thumbnail picture, on which the cursor 153 is located, needs to be sent to the PC 4-2 and hence is monitored and identified at all times, it is checked in the step S79 whether or not a command for display of the full picture display has been made for the thumbnail picture of the specified thumbnail URL.

Based on the so specified thumbnail URL, the PC 4-1 accesses the picture management server 2 The picture management server 2 manages the full picture URL, in association with the thumbnail URL, as explained with reference to FIG. 2. Thus, the picture management server 2 reads out, from the storage unit 28, the full picture URL, corresponding to the thumbnail URL from the PC 4-1, to send the so read out full picture URL to the PC 4-1.

The processing of acquiring the full picture URL in the step S80 is carried out by receiving in this manner the full picture URL sent from the picture management server 2.

Meanwhile, in case the data of the thumbnail URL is sent from the picture management server 2, and the data of the full picture URL is sent simultaneously, it is also possible that the thumbnail URL of the thumbnail picture, the full picture of which has been commanded to be demonstrated on the PC 4-1, is identified by the PC 4-1, and that the full picture URL, associated with the so specified thumbnail URL, is specified (acquired).

On acquisition of the fill picture URL, the PC 4-1 in a step S81 sends the so acquired full picture URL to the PC 4-2. When the full picture URL is sent to the PC 4-2, the command for demonstrating the full picture, in other words, for demonstrating only one picture on the display 101′, is sent simultaneously. The following are exemplary data pertinent to this command:

<query xmls=‘urn:schema-sssy-com.albumshare:service’>

<display type =‘display type’>

URL </url>of the <url>demonstrated picture

</display>

Of the above data, data of ‘display type’ is a portion showing a command that a full picture or a thumbnail picture shall be displayed, while data of the portion shown directly below the ‘display type’, that is, data of “URL </url> of the <url> demonstrated picture”, specifies the full picture URL of the picture displayed to the full size, when the ‘display type’ has been set to the full picture, while specifying the thumbnail URL of the thumbnail picture, where the cursor 153 (153′) is located, when the ‘display type’ has been set to the thumbnail picture.

As the processing for transmission is being executed for the PC 4-2, the PC 4-1 in a step S82 acquires picture data of the full picture from the picture management server 2, based on the full picture URL acquired. Since the similar operation is executed on the PC 4-2, this PC 4-2 acquires the picture data of the same full picture.

Since the picture data of the same full picture are acquired on the PC 4-1 and on the PC 4-2, the same full picture is demonstrated on the display 101 of the PC 4-1 and on the display 101′ of the PC 4-2. Thus, the user A and the user B read the same picture.

The previous picture or the next picture may also be displayed, as the full picture is being displayed in this manner. The previous picture or the next picture means the picture as determined on the basis of the sequence relationship of the allocated full picture URL (thumbnail URL associated with the full picture URL). In this case, it is checked in a step S83 whether or not a command has been made to execute the movement to the previous picture or the next picture with respect to the full picture displayed.

Referring again to FIG. 16, this figure shows the state in which the thumbnail picture 151-3 (FIG. 14) is demonstrated as a full picture. In such picture, a ‘previous’ button 161 and a ‘next’ button 162 are provided e.g. below the full picture. The ‘previous’ button 161 is a button for demonstrating the full picture positioned temporally ahead of the current picture, while the ‘next’ button 162 is a button for demonstrating the full picture next following the current picture In the picture shown in FIG. 16, a thumbnail button 163 is also demonstrated below the full picture. This thumbnail button 163 is a button acted on when reversion is to be made to an overview of thumbnail pictures, that is, to a picture shown in FIG. 14.

In the picture provided with these buttons, it is checked in a step S83 whether or not the ‘previous’ button 161 or the ‘next’ button 162 has been actuated. If it is determined in the step S83 that the ‘previous’ button 161 or the ‘next’ button 162 has been actuated, processing reverts to the step S80 to repeat the processing as from this step.

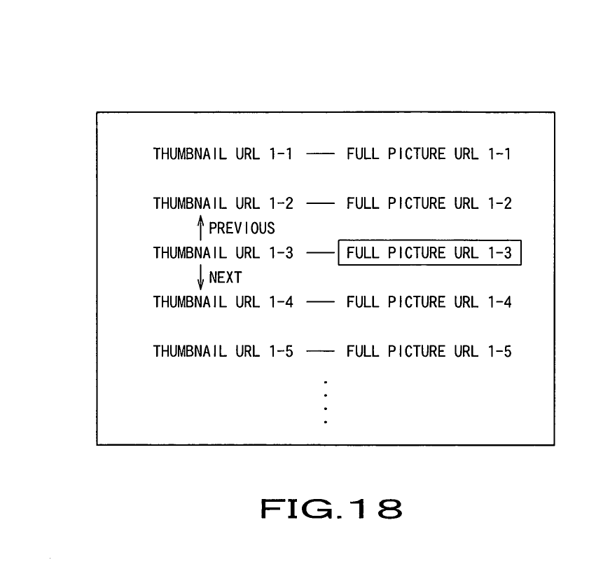

The processing performed on the PC 4-1 when it is verified that the ‘previous’ button 161 or the ‘next’ button 162 has been actuated is now explained by referring to FIG. 18. First, it is assumed that the full picture corresponding to the full picture URL 1-3 has been demonstrated on the display 101. The full picture URL 1-3 is associated with the thumbnail URL 1-3. If, in this state (state A), the user A manipulates the ‘previous’ button 161 to command the display of the previous full picture (switching to the previous full picture), the thumbnail URL 1-2 is read out.

The thumbnail URL 1-2 is located at a previous position in the sequential relationship with respect to the thumbnail URL 1-3. If, in this state A, display of the previous picture, that is, switching to the previous full picture, is commanded, processing on the PC 4-1 reverts to the processing in the step S80 and the thumbnail URL-1-2 is read out and transmitted to the picture management server 2. By this transmission, the full picture URL 1-2, corresponding to the thumbnail URL-1-2 is acquired.

The processing of steps S80 ff. is carried out on the full picture URL 1-2. The processing as from the step S80 ff. has already been explained and hence the corresponding explanation is omitted for simplicity.

When the ‘next’ button 162 is actuated, the processing similar to that when the ‘previous’ button 161 is acted on is repeated. The switching to the full picture is carried out sequentially by repetition of the above-described processing operations.

The data of the full picture URL, sent to the PC 4-2 in a step S81, is now additionally explained. The following data:

<query xmls=‘urn:schema-sssy-com.albumshare: service’>

<display type =‘full picture’>

<url>full picture URL1-2 </url>

</display>

are sent from the PC 4-1 to the PC 4-2 when the display is changed over e.g. from the full picture corresponding to the full picture URL 1-3 to the full picture corresponding to the full picture URL 1-2 (full picture URL associated with the thumbnail URL 1-2).

In the above data, the “display type” is set to the “full picture”. As the URL of the full picture, as the destination of the movement, the “full picture URL 1-2” has been specified. By the transmission of the above data to the PC 4-2, the full picture corresponding to the full picture URL 1-2 is demonstrated on the display 101′ of the PC 4-2.

Returning to the flowchart of FIG. 17, if it is determined in the step S83 that no command has been made for moving the full picture displayed, that is, if in this case the thumbnail button 163 (FIG. 16) has been acted on, processing reverts to the step S78 to repeat the processing as from this step S78.

Referring again to FIG. 18, if the thumbnail button 163 is acted on as the full picture corresponding to the full picture URL 1-3 is demonstrated on the display 101, the thumbnail URL, corresponding to the full picture UR 1-3, is identified. That is, in the present case, the thumbnail URL 1-3 is identified as the thumbnail URL corresponding to the full picture URL 1-3.

It is this thumbnail URL 1-3 that is transmitted to the PC 4-2 as the processing of step S78. The following data:

<query xmls =‘urn:schema-sssy-com.albumshare: service’>

<display type =‘thumbnail picture’>

<url>thumbnail pictureURL 1-3<url>

</display>

are sent as the processing of step S78 to the PC 4-2.

In the above data, the “display type” is set as the “thumbnail picture”. As the URL of the thumbnail picture, on which the cursor 153 is located after switching the display, the “thumbnail picture URL 1-3” has been specified. By the transmission of these data to the PC 4-2, an overview of thumbnail pictures, in which the cursor 153′ is located on the thumbnail picture corresponding to the thumbnail picture URL 1-3, as shown in FIG. 14, is demonstrated on the display 101′ of the PC 4-2.

This processing is executed as the processing by the album share. If, as interrupt processing, the end of the album share is commanded, a notification of the end of the album co-owning session is issued. The following are exemplary data of the end notification:

<query xmls =‘urn:schema-sssy-com.albumshare: service’>

<stop/>

</query>

The album co-owning processing comes to a close by the above data being issued by the PC 4 from which the user has commanded the end of the album session.

With the present invention, described above, plural users located at different places may read the same album at the same time point. Moreover, the information as to which picture in the album being read is the picture of interest may be co-owned by plural users in real-time.

It should be noted that, in case three or more users, instead of two users, are reading the same album, the information which will allow recognition of which user has moved the cursor or which user has commanded the full picture may be displayed in conjunction with the cursor movement.

In the above embodiment, attention to a picture may be directed successfully by causing movement of the cursor 153 or by demonstrating the full picture. Such a function may, however, be added whereby direction may be directed to a portion of the picture. For example, an arrow-lime pointer, indicating a point, may be demonstrated, independently of the cursor 153, on the picture demonstrated on the display 101, this pointer being movable on the picture.

If such function is added, it may be implemented by adding e.g. a function termed a white board. This function, termed the white board, co-owns a sole imaginary white board, among plural users, and allows simultaneously writing figures on this imaginary white board. By applying this function, the pointer may be moved to a preset position to direct the user's attention to a certain portion within the picture.

In the above embodiment, the same album is read by plural users. The present invention may, however, be applied to a case in which plural customers are allowed to read the same catalog for explanation or sale of commodities.

It has been practiced to explain the commodities over telephone as reference is made to a catalog of a paper medium. If, under the situation in which explanation over the telephone has already been made, plural commodities appear on one page, it is a frequent occurrence that, even if a salesman said “this commodity” over the telephone, which commodity was thereby meant was occasionally not satisfactorily transmitted to the customer.

However, by applying the present invention, described above, it is possible to accurately impart to the customer which commodity is meant by “this commodity”. That is, when “this commodity” was said in the conversation over the telephone, the customer may read the commodity (picture) where the cursor 153 is located, or the commodity (picture) demonstrated as a full picture, and comprehend what commodity is meant by “this commodity” accurately.

The following data:

<query xmls=‘urn:schema-sssy-com.adshare: service’>

<display type=“displaty type”>

<url>catalog URL </url>

<command><pos x=“100” y=“200” </command>

</display>

are exemplary data transmitted from the PC 4-1 to the PC 4-2 in case the same catalog is read in the explanation of the commodities, and in case the PC 4-1 is the computer of the salesman and the PC 4-2 is the computer of a customer.

Basically, the above data is similar to that exchanged in reading an album. However, the “catalog URL” is designated as the URL. Moreover, a command “<command><pos x=”100”, y=”200”</command>” is inserted.

In the foregoing explanation, basically a still picture is read, irrespective of whether an album is read or a catalog is read. However, the present invention is not limited to the reading of the still picture and may also be applied to the reading of plural moving pictures at the same time point at different places by plural users.

When the moving picture is read, basically the same processing as that when the still picture is read is carried out between the picture management server 2, user identifying server 3 and the PCs 4. However, there are stored in the picture management server 2 data of moving pictures, which data of the moving pictures are sent over the network 1 to the PC 4. Or, in a stage prior to co-owning, the moving pictures co-owned are stored separately in the PCs 4, designed to co-own the moving pictures.

When the moving pictures are read, the same picture is not read by the users A, with the target being to read the same scene. A scene may be specified based on time. That is, a scene can be specified by designating which hour which minute which second has elapsed since the moving pictures commenced to be reproduced, that is, as from the reference time as set as the reply start point for the moving pictures, until the scene appears. Thus, data including such time data is exchanged, in place of the thumbnail URL and the full picture URL for the still picture, between the PC 4-1 and the PC 4-2. The following data are merely exemplary data:

<query xmls =‘urn:schema-sssy-com.videoshare: service’>

<display program=“http://videostation.jp/ch/2003/02/10/”>

<time>hh:mm:ss:ff</time>

<command>PLAY</command>

</display>

In the above data, data of the moving picture to be co-owned are designated by <display program =“http://videostation.jp/ch/2003/02/10/”>. The time information is supplied by <time>hh:mm:ss:ff</time>to designate a preset scene in the moving pictures. The reproduction from the preset scene of the moving pictures, specified by the above two lines, is commanded by <command>PLAY </command>.

As the commands, such commands as PAUSE, REWIND, FAST FEED SLOW REPLAY and so forth, are also provided, in addition to the PLAY (reproduction), such that various operations provided for the routine video tape recorder are possible.

Thus, according to the present invention, it is possible to co-own moving pictures by plural users to specify a preset scene.

Meanwhile, in the foregoing explanation, the PC 4-1 and the PC 4-2 are of approximately the same capability, such that, in case 15 pictures are demonstrated on the display device of the PC 4-1, 15 pictures may similarly be demonstrated on the display device of the PC 4-2.

However, the present invention may, of course, be applied to the apparatus not having about the same capability.

For example, an album, a catalog or moving pictures may be co-owned between the PC 4 and a mobile phone 5 (FIG. 1) and between the PC 4 and a television receiver 6 (FIG. 1). The following explanation is for a case in which an album is co-owned between the PC 4 and the mobile phone 5.

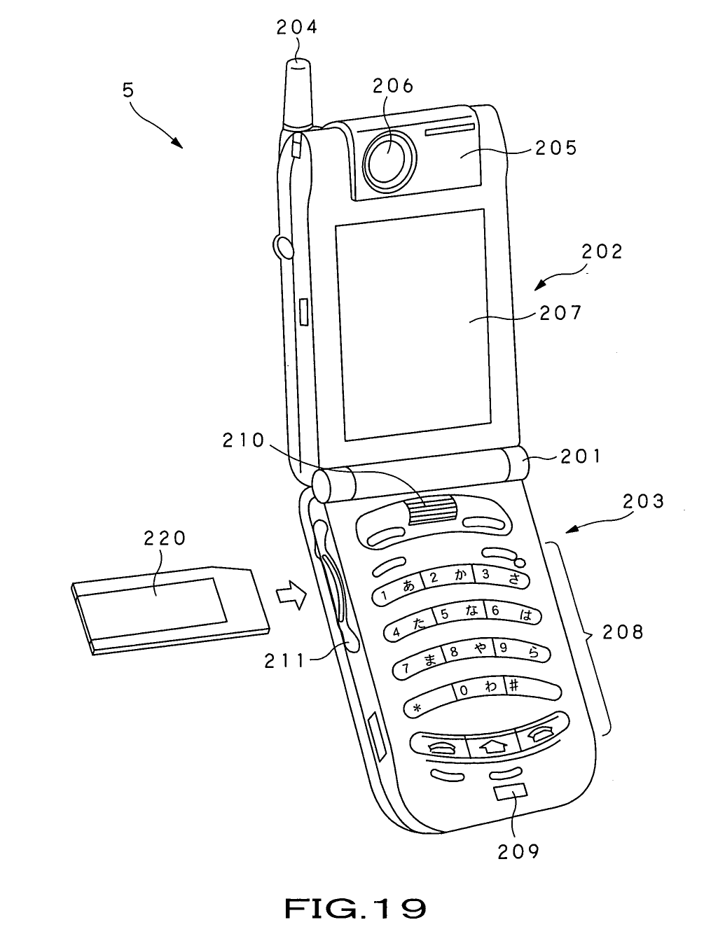

FIG. 19 shows an outer shape of the exemplary mobile phone 5. In FIG. 19, the mobile phone 5 is made up by a display unit 202 and a main body unit 203 interconnected by a center hinge 201, and is collapsible about the hinge 201 as center.

An antenna 204 for transmission/reception is extensibly and retractably mounted to the left upper end of the display unit 202. An electrical wave is transmitted/received over the antenna 204 with a base station designed for controlling the connection of the mobile phone with the network 1. A camera unit 205, rotatable for an angular extent of approximately 180°, is provided at an upper center part of the display unit 202. A desired target scene or object may be shot by a CCD camera 206 of the camera unit 205.

When the camera unit 205 is rotated, a loudspeaker, not shown, presents itself to take the place of the CCD camera 206, so that the user may hear the sound of call from the loudspeaker.

On the front side of the display unit 202, there is provided a liquid crystal display 207 for demonstrating the contents of an E-mail, simple home pages, or pictures shot by the CCD camera 206 of the camera unit 205, in addition to the state of receipt of electrical waves, residual battery capacity, names or telephone numbers of the counterpart parties, registered as a telephone directory, and call hysteresis.

On the surface of the main body unit 203, there are provided operating keys 208, such as a number keys from 0 to 9, a call key, a redial key, a call end and power key, a clear key or an E-mail key. These operating keys 208 may be used for entering various commands.

On the main body unit 203, there is provided a microphone 209. The user's speech during call is collected by this microphone 209. A rotatable jog dial 210 is provided to an upper part of the operating keys 208 so that the jog dial is slightly protruded from the surface of the main body unit 203. Based on the rotating movement of the jog dial 210, a variety of operations, such as scrolling the list of the telephone directory or the E-mail, demonstrated on the liquid crystal display 207, page turning movements for the simple home page or image feed, may be achieved.

The main body unit 203 is provided with a memory stick slot 211 for mounting a removable memory stick (registered trademark) 220 on an upper left side surface of the main body unit 203, for recording an E-mail, a simple home page or a picture shot by the CCD camera 206, responsive to the user's operations.

Since the memory stick 220 can be mounted on the mobile phone 5, data may be co-owned with other electronic equipment through the memory stick 220.

In the mobile phone 5, shown in FIG. 19, comparison of the display unit 202 (liquid crystal display 207) of the mobile phone 5 with the display unit 101 of the PC 4 reveals that the display unit 202 is generally of a smaller size than the display unit 101. Thus, if the thumbnail pictures 151-1 to 151-12 shown in FIG. 4 are demonstrated on the display unit 101 of the PC 4 in a state of four rows by three columns, and similar display is made on the liquid crystal display 207 of the mobile phone 5, each thumbnail picture on the liquid crystal display is presumably difficult to read.

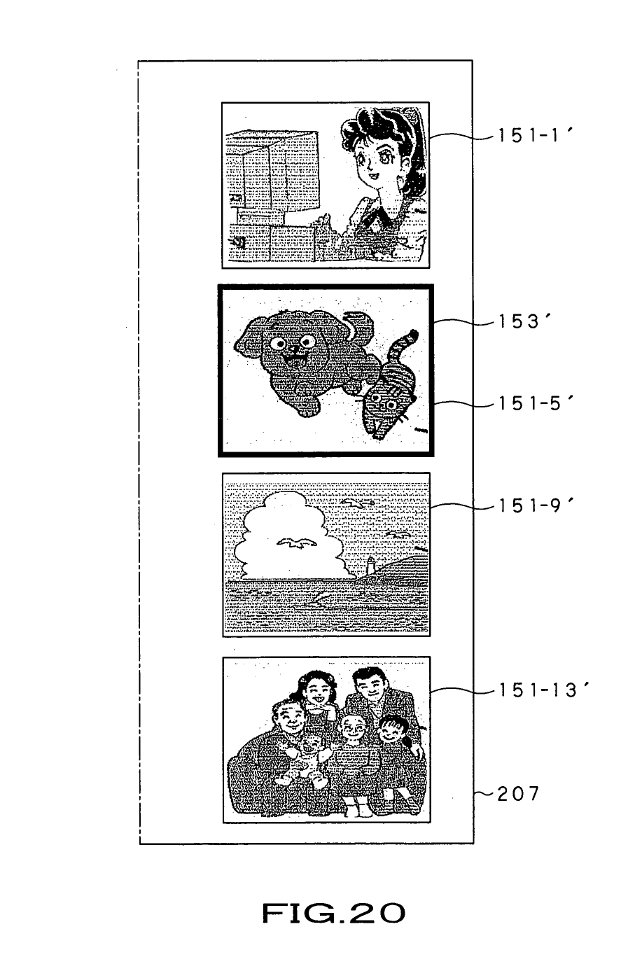

Thus, only a smaller number of thumbnail pictures than the number of the thumbnail pictures demonstrated on the display unit 101 of the PC 4, four in FIG. 20, are shown on the liquid crystal display 207 of the mobile phone 5, as shown in FIG. 20.

The comparison of the pictures shown in FIGS. 14 and 20 reveals that, on the liquid crystal display 207 of the mobile phone 5, shown in FIG. 20, there is displayed, first of all, the thumbnail picture 151-1′ of the same picture pattern as that of the thumbnail picture 151-1 demonstrated on the display unit 101 of the PC 4-1 shown in FIG. 14.

A thumbnail picture 151-5′ of the same picture pattern as the thumbnail picture 151-5, a thumbnail picture 151-9′ of the same picture pattern as the thumbnail picture 151-9, and a thumbnail picture 151-13′ of the same picture pattern as the thumbnail picture 151-13 (a picture located below the thumbnail picture 151-9, and which is not shown in FIG. 14 but displayed on actuating the scroll bar 152) are demonstrated on the liquid crystal display 207.

According to the present invention, if the cursor 153 is moved on the PC 4-1, the thumbnail URL is exchanged, whereby the cursor 153 on the mobile phone 5 is moved. Thus, the thumbnail picture on which is located the cursor 153 and the thumbnail picture on which is located the cursor 153′ may be the thumbnail pictures of the same picture pattern (the thumbnail pictures of the same thumbnail URL), at all times, without regard to the configuration with which the thumbnail picture is displayed.

However, if the text or the voice is used in addition to the movement of the cursor 153, for exchanging the message which will cause the attention to be directed to the preset thumbnail picture, and if different users read the pictures in different display configurations, such that, for example, the user A reads the picture on which the thumbnail pictures are arranged in four rows by three columns, as shown in FIG. 14, and the user B reads the picture on which the thumbnail pictures are arranged in one row by four columns, as shown in FIG. 20, it may be feared that communication is not successful.

For example, if the user S reading the picture of the display configuration shown in FIG. 14 states, in the form of a text or a speech message: “the third picture from right is good”, this third picture from right is not present for the user B reading the display configuration shown in FIG. 20, such that the user B cannot comprehend which picture is meant by the third picture from right.

A means for eliminating this inconvenience is hereinafter explained. Here, a case in which the user A reads pictures arranged in a four column by three row configuration (4×3 configuration), shown in FIG. 14, on the display unit 101 of the PC 4-1, while the user B reads pictures arranged in a one column by four row configuration (1×4 configuration), shown in FIG. 20, on the display unit 207 of the mobile phone 5, is taken as an example for explanation.

First, the concept of a virtual display area is introduced. It is assumed that the virtual display area is an imaginary display area for thumbnail pictures provided for unifying (supervising) different display configurations. The size of the virtual display area is set in keeping with the display configuration (number of pictures that can be displayed) from one display unit to another. Such virtual display area is supervised by e.g. the user identifying server 3.

Here, one of the display units is for 4×3 (FIG. 14), while the other is for 1×4 (FIG. 20). The maximum number of the pictures for the horizontal direction and that for the vertical direction are set, so that the size of the virtual display area is 4×4.

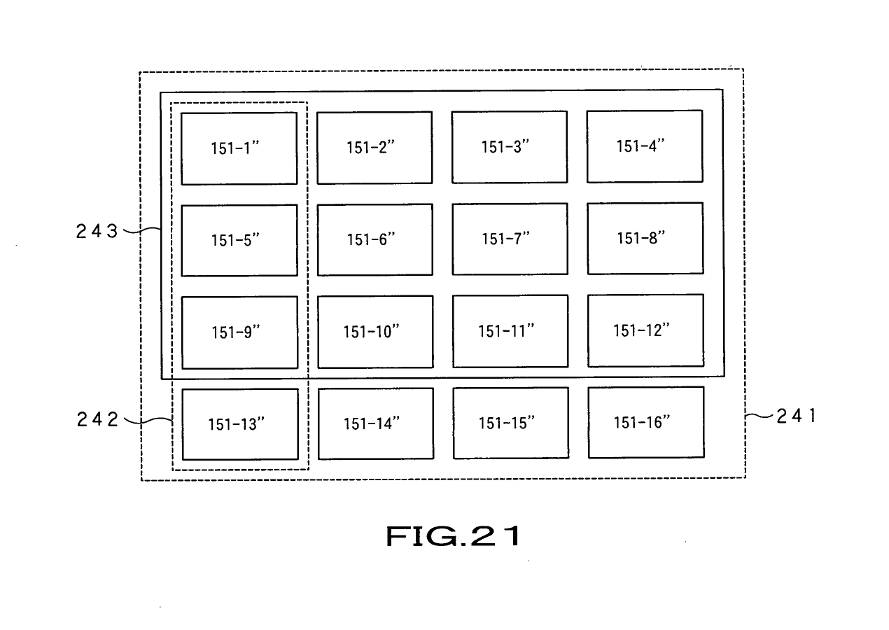

FIG. 21 illustrates the virtual display area. FIG. 21 shows a virtual display area 241. The virtual display area 241, shown in FIG. 21, is a 4×4 area. In the 4×4 area, thumbnail pictures 151-1″ to 151-16″ are demonstrated. For example, the thumbnail picture 151-1″ corresponds to the thumbnail picture 151-1 (FIG. 14) (thumbnail picture 151-1′ (FIG. 20)).

In the virtual display area 241, there are provided an area 242 and an area 243. The area 242 indicates an area in which thumbnail pictures are demonstrated on the liquid crystal display 207, while the area 243 indicates an area in which thumbnail pictures are demonstrated on the display unit 101.

FIG. 21 shows a state in which the cursor 153 (153′) is located on the thumbnail picture 151-5″. The areas 242, 243 include the corresponding thumbnail pictures 151-5″.

It is now assumed that, from this state, the user B reading the picture shown in FIG. 20 causes downward movement of the cursor 153′ such that the cursor 153′ is now located on the thumbnail picture 151-13′.

On such movement of the cursor 153′, control is exercised on the side of the PC 4-1 so that the cursor 153 is moved onto the thumbnail picture of the same picture pattern, as described previously. In keeping with such movement, the areas 242, 243 in the virtual display area 241 are also moved.

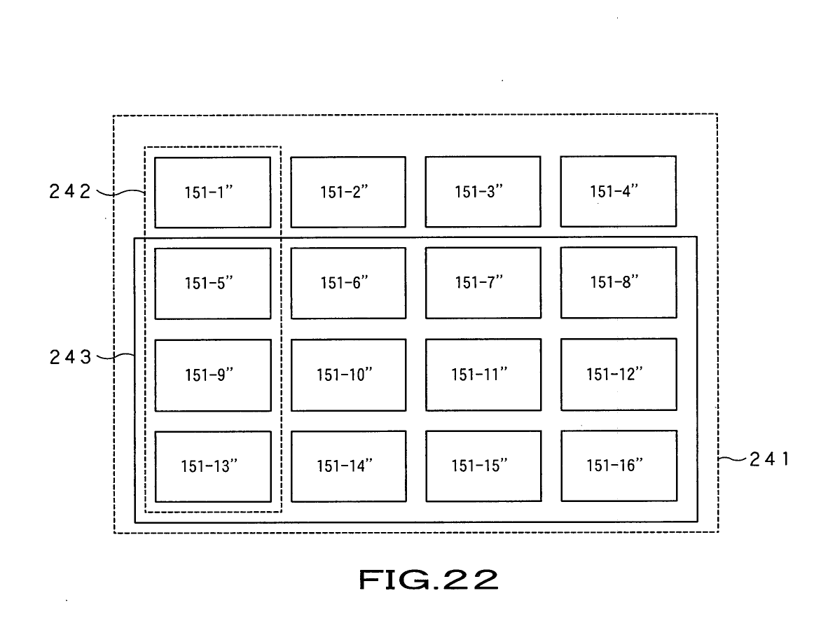

That is, in such case, the area 243 is moved down a distance equal to one thumbnail picture, as shown in FIG. 22. Although the area 242 already includes the thumbnail picture 151-13″ from the state shown in FIG. 21 and hence is not moved, the area 243 is moved down so as to comprehend the thumbnail picture 151-13″.

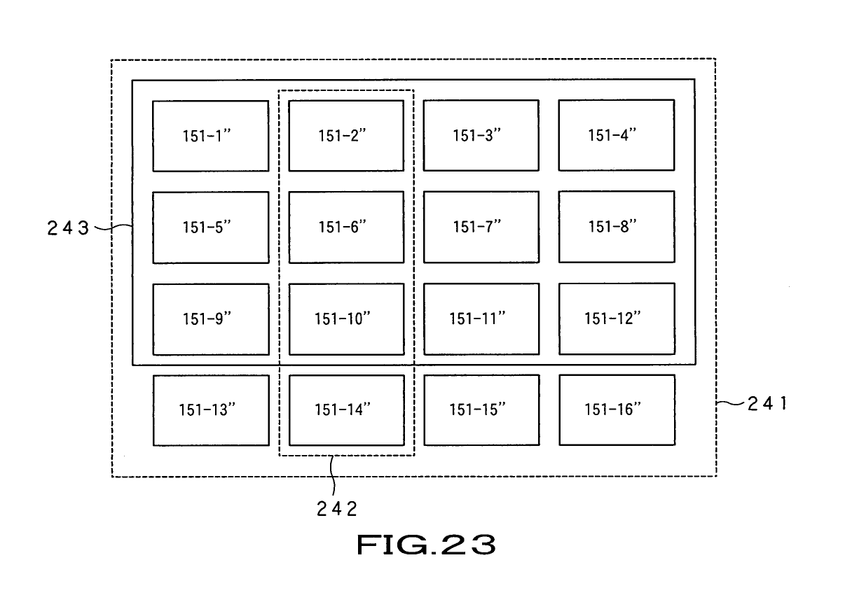

In case the cursor 153′ is moved down in such state in which the thumbnail pictures 151-1′, 151-5′, 151-9′ and 151-13′, shown in FIG. 20, are displayed, and in which the cursor 153′ is located on the thumbnail picture 151-13′, the area 242 in the virtual display area 241 is moved to an area comprehending the next column, as shown in FIG. 23.

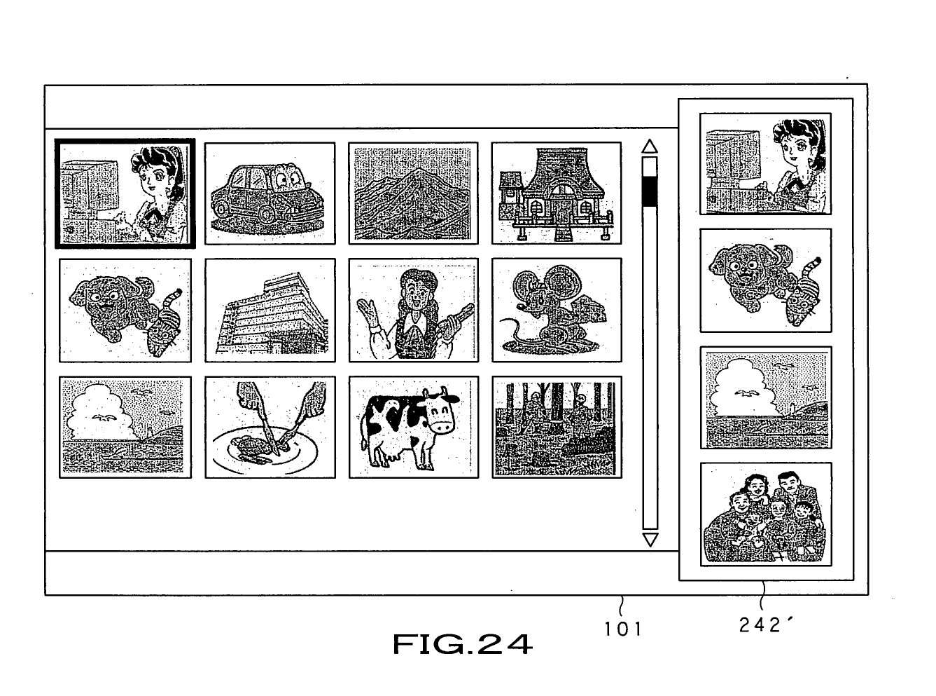

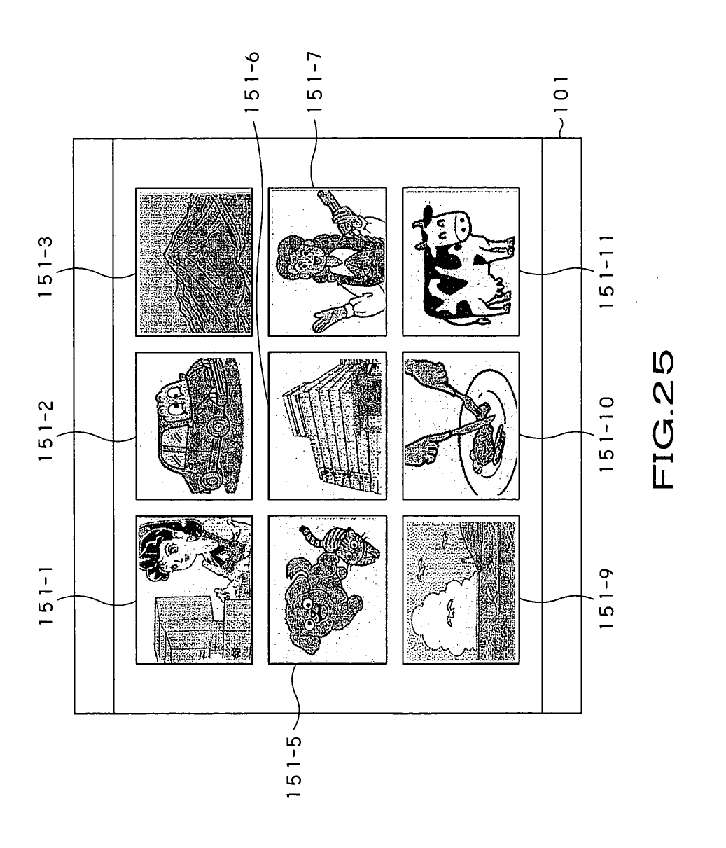

By introducing the concept of the virtual display area 241, it becomes possible to demonstrate the picture, such as is shown in FIG. 24, on the display unit 101 of the PC 4-1 of the user A. In this case, the picture is displayed on the display unit 101 of a larger display size.

The picture shown on the left side of FIG. 24 is equivalent to the picture shown in FIG. 14. The right side picture shown in FIG. 24 is an area 242′ where the thumbnail picture in the area 242 is displayed.

The thumbnail pictures (thumbnail URLs) displayed in this area 242′ are displayed by movement of the data of the thumbnail pictures included in the area 242 of the virtual display area 241 to the PC 4-1. The size of the area 242′ need not be the size shown in FIG. 24 and may be such as to allow the reference reading by the user A. The area 242′ itself may be displayed such as to help the user to grasp the picture only roughly and hence may be displayed to a resolution lower than for the thumbnail picture, such as the thumbnail picture 151-1, displayed for the user A.

That is, the picture shown in FIG. 24 demonstrates not only the own picture but also the picture of the counterpart party. Thus, the user A may refer to the area 242′ to recognize that, for example, the thumbnail picture displayed “third from right” on the own picture is demonstrated second from top, that is, a thumbnail picture not demonstrated on the picture on the counterpart party. In this manner, the user employing an apparatus having a larger display area may take account of the apparatus with a small display area of the counterpart party of communication, so that the users A and B may communicate with each other more smoothly.

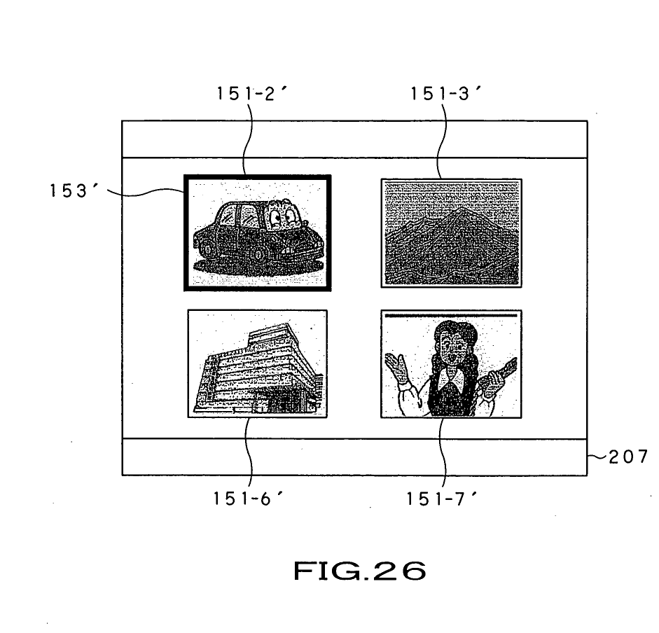

Another mode of setting the virtual display area is now explained. It is assumed that thumbnail pictures are demonstrated in a 3×3 display configuration on the display unit 101 of the PC 4-1 of the user A, thumbnail pictures are demonstrated in a 2×2 display configuration on the liquid crystal display 207 of the mobile phone 5 of the user B, as shown in FIG. 26, and that 15 pictures are included in the album co-owned by the users A and B.

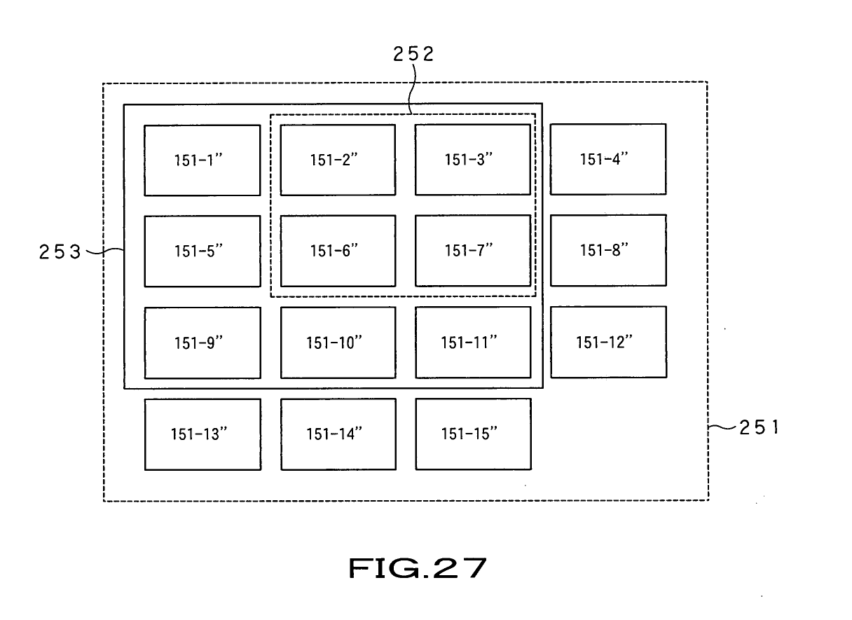

The virtual display area in such state is now explained with reference to FIG. 27. In the case of FIG. 27, the virtual display area is a virtual display area 251. The size of the virtual display area 251 is determined by the number of pictures contained in the album. In determining the size of the virtual display area, the square root of the number of the pictures contained in the album is calculated and the number larger than 0.5 is reckoned as a whole number.

Specifically, the number of pictures contained in the album is 15, in this case, so that a number approximately equal to 3.87 is calculated as a square root of 15. Thus, the number four is found in this case. Based on this number, the size of the virtual display area 251 is set to 4×4.

Within the virtual display area 251, 15 thumbnail pictures 151-1″ to 151-15″ are arrayed in a 4×4 configuration, as shown in FIG. 27. The area within the virtual display area 251, corresponding to the display area of the liquid crystal display 207 of the mobile phone 5, is an area 252. The area within the virtual display area 251, corresponding to the display area of the display unit 101 of the PC 4-1, is an area 253.

It is assumed that, in the state shown in FIG. 27, the cursor 153 (153′) is located on the thumbnail picture 157-7″. The areas 252, 253 are retained to be areas containing the thumbnail picture 157-7″. It is now assumed that, from this state, the user A or the user B moves the cursor 153 (153′) to a position lying on the thumbnail picture 151-8″.

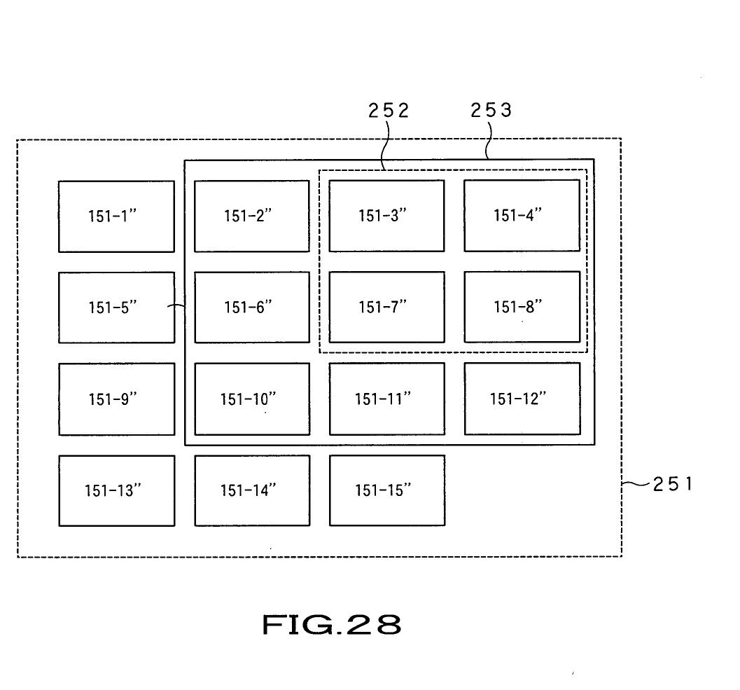

If such movement of the cursor 153 (153′) is made, the areas 252, 253 are also moved, in keeping with the movement, as shown in FIG. 28. The area 252 is also moved towards right such as to contain the thumbnail picture 151-8″ therein. Similarly, the area 252 is also moved towards right such as to contain the thumbnail picture 151-8″ therein.

In this manner, the areas 252, 253 in the virtual display area 251 are moved in keeping with the movement of the cursor 153 (153′), as shown in FIG. 28. In the case shown in FIGS. 27 and 28, the area 252 is an area contained in the area 253. That is, the area 252 with a smaller display zone is contained in the area 253 with a larger display zone.

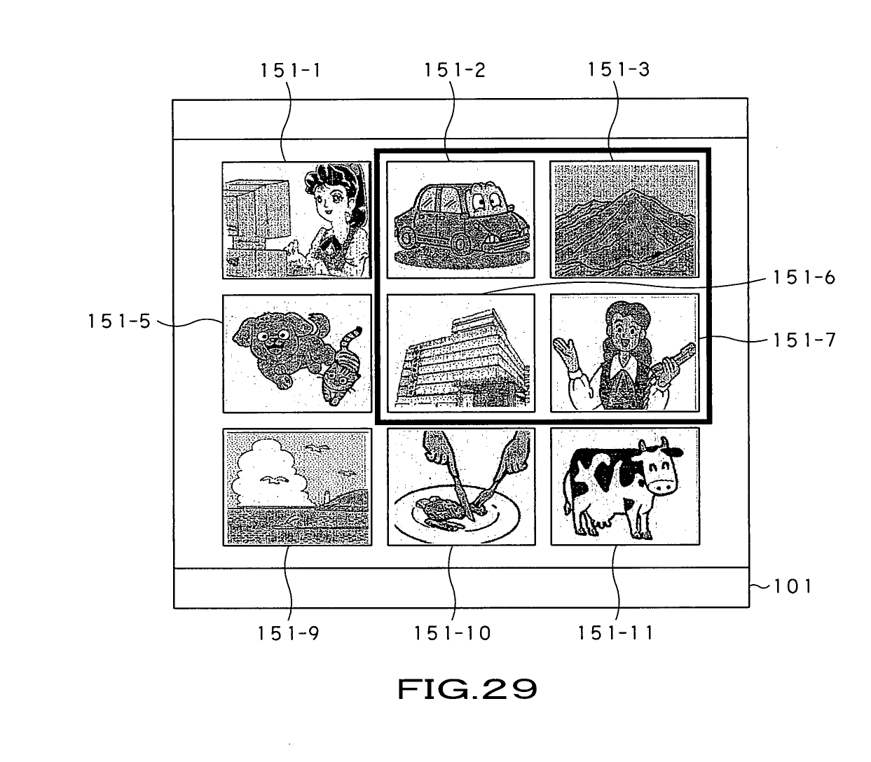

In such case, simply a frame 261 may be demonstrated on the display unit 101 of the PC 4-1 of the user A, as shown in FIG. 29.

In the illustrative picture of the display unit 101 of the user A, shown in FIG. 29, the thumbnail picture is demonstrated in a 3×3 configuration, while the frame 261, showing the display area demonstrated on the liquid crystal display 207 of the mobile phone 5 of the user B, is simultaneously demonstrated on the display unit 101.

The user A may recognize that the thumbnail picture in the frame 261 is being read by the user B.

If the frame 261 is not displayed, and the user A, directing his/her attention to the thumbnail picture 151-1, sends a message: “picture at the upper left end” to the user B with the text or the message, the user B recognizes that the picture referred to in the message is the thumbnail picture 151-2. Thus, it may be feared that communication does not proceed smoothly.

However, since the frame 261 is now demonstrated on the display unit 101 of the user A, the user A is able to recognize that the “picture at the upper left end” is not the thumbnail picture 151-1, but the thumbnail picture 151-2, on the picture being read by the user B, so that it is possible for the communication to proceed smoothly to avoid the non-smooth communication such as is shown in the foregoing.

In the above-described embodiment, the concept of the virtual display area is introduced, and the picture with a smaller display zone is demonstrated as a reference picture in the larger display area. Alternatively, similar display may also be made without introducing the concept of the virtual display area.

In case the concept of the virtual display area is introduced, it is sufficient to transmit the thumbnail URLs of the totality of the thumbnail pictures demonstrated on the liquid crystal display 207 of the mobile phone 5 from the mobile phone 5 to the PC 4-1.

The picture such as is shown in FIG. 29 may be displayed if the mobile phone 5 sends to the PC 4-1 the thumbnail URLs corresponding to the thumbnail pictures 151-2, 151-3, 151-6 and 151-7, the PC 4-1 then executing the processing of demonstrating the frame 261 surrounding the received thumbnails URLs on the display unit 101.

By so doing, it is possible to demonstrate the picture shown in FIG. 29. Similarly,, by exchanging the thumbnail URL, it is possible to demonstrate the picture, such as is shown in FIG. 24, on the display unit 101.

Thus, according to the present invention, plural users may read the same album, catalog or the moving pictures at the same time point at different locations. Moreover, the pictures or scenes of interest may be designated in real-time. In case messages are exchanged with the text or with the voice, it is possible to prevent mistaken recognition between the sending and receiving side users to assure smoother communication.

In the above-described embodiment of the present invention, it has been explained that, in transmitting the thumbnail URL from the PC 4-1 to the PC 4-2, only the thumbnail URL is transmitted. It is however possible to transmit the picture data corresponding to the thumbnail URL simultaneously.

That is, in the above explanation, the PC 4-1 and the PC 4-2 separately accesses the picture management server 2 to acquire the picture data independently of each other. Alternatively, the picture data acquired by the PC 4-1 may be provided to the PC 4-2, without the PC 4-2 itself accessing the picture management server 2.

The above-described sequence of operations may be executed by the hardware having the respective functions. When the sequence of operations is to be executed by the software, the software is installed from the recording medium to a computer in which the programs of the software are built into the dedicated hardware, or into e.g. a general-purpose personal computer in which various functions may be executed by installing various programs.

Referring to FIG. 3, the recording medium is formed by a package medium, distributed to the user for supplying the user with a program, in addition to the personal computer, including a magnetic disc 41 (in turn including a flexible disc), an optical disc 42 (including a CD-ROM (Compact Disc-Read Only memory)), a DVD (Digital Versatile Disc), a magneto-optical disc, (including the Mini-Disc (MD, a registered trademark)) and a semiconductor memory 44, or by a hard disc, supplied to the user in a state pre-installed on the computer, and which includes a ROM 22 having program stored therein and a storage unit 28.

In the present specification, the steps stating the program supplied by the medium include not only the processing carried out chronologically in accordance with the sequence stated therein, but also the processing not necessarily executed in parallel or separately without being carried out chronologically.

In the present specification, the system denotes an entire apparatus made up by plural devices.

What is claimed is:

1. An information processing system made up by a first apparatus for supervising data, a second apparatus for exploiting said data, and a third apparatus for connecting said second apparatus to another apparatus, said information processing system comprising
supplying means for supplying said data from said first apparatus to said second apparatus;
connecting means for connecting said second apparatus to said other apparatus over a network by said third apparatus; and
transmitting means for transmitting the data supplied by said supplying means to said second apparatus from said second apparatus, connected by said connecting means, to said other apparatus.

2. The information processing system according to claim 1 wherein said first apparatus supervises first picture data of a thumbnail picture, a first URL associated with said first picture data, a second URL associated with said first URL and second picture data for enlarged display of said thumbnail picture associated with said second URL.

3. The information processing system according to claim 2 wherein, in case said first URL is supplied by said supplying means, said first URL is sent to said other apparatus by said transmitting means, and said other apparatus includes means for acquiring, from the first apparatus, the first picture data associated with the first URL transmitted from said transmitting means.

4. The information processing system according to claim 2 wherein said second apparatus is supplied from said first apparatus with said first URL and, in case said second picture data for enlarging a thumbnail picture corresponding to said first URL has become necessary, said second apparatus sends said first URL to said first apparatus;
said second apparatus acquiring said second URL, returned from said first apparatus as being associated with said first URL;
said second apparatus further acquiring said second picture data from said first apparatus based on the second URL acquired.

5. The information processing system according to claim 1 wherein said data transmitted by said transmitting means is sent to said other apparatus through said third apparatus.

6. An information processing apparatus comprising
first acquisition means for acquiring a first URL associated with first picture data supervised by a first apparatus;
connection means for connecting to a second apparatus for exchanging data therewith;
first supplying means for supplying said first URL, obtained by said first acquisition means, to said second apparatus, connected by said connecting means;
second acquisition means for accessing said first apparatus, based on said first URL, obtained by said first acquisition means, for acquiring said first picture data;
displaying means for displaying a picture derived from said first picture data obtained by said second acquisition means;
specifying means for specifying said first URL associated with said picture data of said picture, among said pictures demonstrated on said display means, on which a cursor is located; and
second supplying means for supplying said first URL, specified by said specifying means, to said second apparatus, connected by said connecting means.

7. The information processing apparatus according to claim 6 further comprising
verifying means for verifying whether or not a command has been issued for enlarging the picture derived from said first picture data associated with said first URL specified by said specifying means;
third acquisition means for transmitting, in case said verifying means has determined that the command has been issued for enlarging said picture, said first URL specified by said specifying means to said first apparatus, for obtaining a second URL associated with said first URL; and
third supplying means for supplying said second URL as obtained by said third acquisition means, to said second apparatus.

8. The information processing apparatus according to claim 6 wherein the connection by said connection means is via a third apparatus.

9. The information processing apparatus according to claim 6 wherein said display means demonstrates a picture derived from said first picture data acquired by said second acquisition means, and further demonstrates the information for allowing a user to recognize a picture demonstrated on a display unit of said second apparatus

10. An information processing method comprising
a first acquisition control step of controlling the acquisition of a first URL associated with first picture data supervised by a first apparatus;
a connecting step of providing for connection to a second apparatus for enabling data exchange therewith;
a first supplying step for supplying said first URL, the acquisition of which has been controlled by the processing of said first acquisition control step, to said second apparatus, connected by processing in said connecting step;
a second acquisition control step of accessing said first apparatus, based on said first URL, obtained by the processing of said first acquisition control step, for controlling the acquisition of said first picture data;
a display control step of controlling the display of a picture derived from said first picture data, the acquisition of which has been controlled by the processing of said second acquisition control step;
a specifying step of specifying said first URL associated with said first picture data of the picture, among said pictures display-controlled by the processing by said display control step, on which a cursor is located; and
a second supplying step of supplying said first URL, specified by said specifying step, to said second apparatus, connected by the processing of said connecting step.

11. A recording medium having recorded thereon a computer-readable program, said computer-readable program including
a first acquisition control step of controlling the acquisition of a first URL associated with first picture data supervised by a first apparatus;
a connecting step of providing for connection to a second apparatus for enabling data exchange therewith;
a first supplying step for supplying said first URL, the acquisition of which has been controlled by the processing of said first acquisition control step, to said second apparatus, connected by processing in said connecting step;
a second acquisition control step of accessing said first apparatus, based on said first URL, obtained by the processing of said first acquisition control step, for controlling the acquisition of said first picture data;
a display control step of controlling the display of a picture derived from said first picture data, the acquisition of which has been controlled by the processing of said second acquisition control step;
a specifying step of specifying said first URL associated with said first picture data of the picture, among said pictures display-controlled by the processing by said display control step, on which a cursor is located; and
a second supplying step of supplying said first URL, specified by said specifying step, to said second apparatus, connected by the processing of said connecting step.

12. A program for having a computer execute
a first acquisition control step of controlling the acquisition of a first URL associated with first picture data supervised by a first apparatus;
a connecting step of providing for connection to a second apparatus for enabling data exchange therewith;
a first supplying step for supplying said first URL, the acquisition of which has been controlled by the processing of said first acquisition control step, to said second apparatus, connected by processing in said connecting step;
a second acquisition control step of accessing said first apparatus, based on said first URL, obtained by the processing of said first acquisition control step, for controlling the acquisition of said first picture data;
a display control step of controlling the display of a picture derived from said first picture data, the acquisition of which has been controlled by the processing of said second acquisition control step;
a specifying step of specifying said first URL associated with said first picture data of said picture, among said pictures display-controlled by the processing by said display control step, on which a cursor is located; and
a second supplying step of supplying said first URL, specified by said specifying step, to said second apparatus, connected by the processing of said connecting step.
